(19) United States
(12) Patent Application Publication
(10) Pub. No.: US 2025/0252933 A1
(43) Pub. Date: Aug. 7, 2025

(54) DISPLAY APPARATUS

(71) Applicant: Samsung Display Co., Ltd., Yongin-si (KR)

(72) Inventors: Minki Yang, Yongin-si (KR); Changkyu Jin, Yongin-si (KR); Daehyun Kim, Yongin-si (KR); Sunghwan Kim, Yongin-si (KR)

(73) Assignee: Samsung Display Co., Ltd., Yongin-si (KR)

(21) Appl. No.: 18/968,157

(22) Filed: Dec. 4, 2024

(30) Foreign Application Priority Data
Feb. 2, 2024 (KR) 10-2024-0016911
Jun. 20, 2024 (KR) 10-2024-0080203

(51) Int. Cl. G09G 3/3275

(52) U.S. Cl. CPC G09G 3/3275; G09G 2300/0426; G09G 2310/08

(57) ABSTRACT

A display apparatus including a display including sub-pixel circuits, data lines, a data driving circuit that outputs data signals through output lines, a data distributor selectively connecting each of the output lines to one of a corresponding pair of data lines among the data lines according to a first control signal and a second control signal, and a control circuit that alternately outputs the first control signal and the second control signal, wherein the data lines include a first data line and a second data line that receive data signals according to different ones of the first and second control signals, and a third data line and a fourth data line that receive data signals according to a same one of the first and the second control signals

### CROSS-REFERENCE TO RELATED APPLICATION(S)

This application claims priority under 35 U.S.C. § 119 to and benefits from Korean Patent Application Nos. 10-2024-0016911 filed on Feb. 2, 2024 and 10-2024-0080203 filed on Jun. 20, 2024 and in the Korean Intellectual Property Office, the entire contents of which are incorporated herein by reference.

### BACKGROUND

### 1. Technical Field

One or more embodiments relate to display apparatuses.

### 2. Description of the Related Art

A display apparatus may include multiple pixels. Each of the pixels may include a light-emitting diode and a pixel circuit for controlling luminance or the like of the light-emitting diode. The pixel circuit may include transistors and capacitors, which are connected to lines such as data lines, gate lines, or voltage lines.

In order to apply data signals to multiple data lines, respectively, a data driving circuit is required to include a number of output lines corresponding to a number of the data lines, and as multiple integrated circuits are required, the manufacturing costs thereof increase.

### SUMMARY

One or more embodiments include a display apparatus with a reduced number of output lines in a data driving circuit. In addition, one or more embodiments include a display apparatus with reduced image quality degradation due to interference between adjacent data lines. However, this objective is only an example, and the scope of one or more embodiments is not limited thereby.

Additional aspects will be set forth in part in the description which follows and, in part, will be apparent from the description, or may be learned by practice of the presented embodiments of the disclosure.

According to one or more embodiments, a display apparatus may include a display including sub-pixel circuits arranged in a row direction and column direction and data lines connected to corresponding sub-pixel circuits, a data driving circuit that outputs data signals through output lines, a data distributor selectively connecting each of the output lines to one of a pair of data lines among the data lines according to a first control signal and a second control signal, and a control circuit that alternately outputs the first control signal and the second control signal, wherein the data lines may include a first data line, a second data line, a third data line, and a fourth data line, the first data line and the second data line may be neighboring each other and may receive corresponding data signal, respectively according to different ones of the first control signal and the second control signal, and the third data line and the fourth data line may be neighboring each other and may receive corresponding data signal, respectively according to a same one of the first control signal and the second control signal, the first data line and the second data line may be spaced apart from each other with by least one sub-pixel circuit column, and two neighboring data lines among the first data line, the second data line, the third data line, and the fourth data line may be arranged to face each other.

In an embodiment, each of the data lines may be arranged on either a first side or second side of a corresponding sub-pixel circuit column, and the third data line may be arranged on the second side of the corresponding sub-pixel circuit column, and the fourth data line may be arranged on the first side of the corresponding sub-pixel circuit column.

In an embodiment, wherein the data lines may further include a fifth data line and a sixth data line, the fifth data line and the sixth data line may be neighboring each other and may receive corresponding data signal, respectively according to a same one of the first control signal and the second control signal, the fifth data line may be connected to a first output line from among the output lines according to the first control signal, the sixth data line may be connected to a second output line from among the output lines according to the first control signal, the first data line may be connected to a third output line from among the output lines according to the first control signal, and the second data line may be connected to the first output line according to the second control signal, the third data line may be connected to the second output line according to the second control signal, and the fourth data line may be connected to the third output line according to the second control signal.

In an embodiment, each of the first data line and the second data line may be arranged on the first side of the corresponding sub-pixel circuit column.

In an embodiment, a sub-pixel circuit column that is connected to the first data line may be disposed between the first data line and the second data line.

In an embodiment, the fifth data line may be disposed on the first side of the corresponding sub-pixel circuit column, and the sixth data line may be disposed on the second side of the corresponding sub-pixel circuit column.

In an embodiment, a sub-pixel circuit column connected to the fifth data line and a sub-pixel circuit column connected to the sixth data line may overlap a driving voltage line (e.g., single driving voltage line).

In an embodiment, the first data line may be arranged on the first side of the corresponding sub-pixel circuit column, and the second data line may be arranged on the second side of the corresponding sub-pixel circuit column.

In an embodiment, the sub-pixel circuit column that is connected to the first data line and the sub-pixel circuit column that is connected to the second data line may overlap a driving voltage line (e.g., single driving voltage line).

In an embodiment, the fifth data line and the sixth data line may face each other.

According to an embodiment, an electronic device may include the display apparatus.

According to an embodiment, the electronic device may be a mobile phone, a smartphone, a tablet personal computer, a mobile communication terminal, an electronic notebook, an electronic book, a portable multimedia player, a navigation, an ultra-mobile PC, a television, a laptop, a monitor, a billboard, an Internet-of-Things device, a smart watch, a watch phone, a glasses-type display, a head-mounted display, a center information display disposed on a center fascia or dashboard of a vehicle, a room mirror display, or a display disposed on a rear surface of a front seat of the vehicle.

According to one or more embodiments, a display apparatus may include a display including sub-pixel circuits arranged in a row direction and column direction, data lines connected to corresponding sub-pixel circuits, first voltage transfer lines extending in the column direction, a data driving circuit that outputs a data signal through output lines, a data distributor selectively connecting each of the output lines to one of a pair of data lines among the data lines according to a first control signal and a second control signal, and a control circuit that alternately outputs the first control signal and the second control signal, wherein the data lines may include first groups and second groups, each of the first groups may include a first data line, a second data line, and a third data line that receive data signals according to the first control signal, and each of the second groups may include a fourth data line, a fifth data line, and a sixth data line that receive data signals according to the second control signal, the first groups and the second groups may be alternately arranged in the row direction, and one of the first voltage transfer lines may be disposed between the third data line and the fourth data line.

In an embodiment, each of the data lines may be arranged on either a first side or second side of a corresponding sub-pixel circuit column, and each of odd-numbered data lines may be arranged on the second side of the corresponding sub-pixel circuit, and each of even-numbered data lines may be arranged on the first side of the corresponding sub-pixel circuit.

In an embodiment, the first data line may be connected to a first output line from among the output lines according to the first control signal, the second data line may be connected to a second output line from among the output lines according to the first control signal, the third data line may be connected to a third output line from among the output lines according to the first control signal, the fourth data line may be connected to the first output line according to the second control signal, the fifth data line may be connected to the second output line according to the second control signal, and the sixth data line may be connected to the third output line according to the second control signal.

In an embodiment, the display may further include second voltage transfer lines extending in the row direction, and the first voltage transfer lines may be connected to the second voltage transfer lines.

In an embodiment, six data lines may be disposed between two neighboring first voltage transfer lines from among the first voltage transfer lines.

According to an embodiment, an electronic device may include the display apparatus.

According to an embodiment, the electronic device may be a mobile phone, a smartphone, a tablet personal computer, a mobile communication terminal, an electronic notebook, an electronic book, a portable multimedia player, a navigation, an ultra-mobile PC, a television, a laptop, a monitor, a billboard, an Internet-of-Things device, a smart watch, a watch phone, a glasses-type display, a head-mounted display, a center information display disposed on a center fascia or dashboard of a vehicle, a room mirror display, or a display disposed on a rear surface of a front seat of the vehicle.

According to one or more embodiments, a display apparatus may include a display including sub-pixel circuits arranged in a row direction and a column direction, data lines connected to corresponding sub-pixel circuits, and first voltage transfer lines extending in the column direction, a data driving circuit that outputs a data signal through output lines, a data distributor selectively connecting each of the output lines to one of a pair of data lines among the data lines, and a control circuit that alternately outputs the first control signal and the second control signal, wherein the data lines may include first groups and second groups, each of the first groups may include a first data line, a second data line, and a third data line that are connected to a corresponding one of the output lines according to the first control signal, and each of the second groups may include a fourth data line, a fifth data line, and a sixth data line that are connected to a corresponding one of the output lines according to the second control signal, the first group and the second group may be alternately arranged in the row direction, and one of the first voltage transfer lines may be disposed between the sixth data line and the first data line.

In an embodiment, each of the data lines may be arranged on either a first side or second side of a corresponding sub-pixel circuit column, each of odd-numbered data lines may be arranged on the first side of the corresponding sub-pixel circuit column, and each of even-numbered data lines may be arranged on the second side of the corresponding sub-pixel circuit column.

In an embodiment, the first data line may be connected to a first output line from among the output lines according to the first control signal, the second data line may be connected to a second output line from among the output lines according to the first control signal, the third data line may be connected to a third output line from among the output lines according to the first control signal, the fourth data line may be connected to the first output line according to the second control signal, the fifth data line may be connected to the second output line according to the second control signal, and the sixth data line may be connected to the third output line according to the second control signal.

In an embodiment, the display may further include second voltage transfer lines extending in the row direction, and the first voltage transfer lines may be connected to the second voltage transfer lines.

In an embodiment, six data lines may be disposed between two neighboring first voltage transfer lines from among the first voltage transfer lines.

According to one or more embodiments, an electronic device may include the display apparatus.

The electronic device may be a mobile phone, a smartphone, a tablet personal computer, a mobile communication terminal, an electronic notebook, an electronic book, a portable multimedia player, a navigation, an ultra-mobile PC, a television, a laptop, a monitor, a billboard, an Internet-of-Things device, a smart watch, a watch phone, a glasses-type display, a head-mounted display, a center information display disposed on a center fascia or dashboard of a vehicle, a room mirror display, or a display disposed on a rear surface of a front seat of the vehicle.

Other aspects, features and advantages in addition to those described above will become apparent from the following drawings, claims and detailed description of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a plan view schematically illustrating a display apparatus according to an embodiment;

FIGS. 2A to 2C are schematic diagrams of equivalent circuits each illustrating a sub-pixel included in a display apparatus according to an embodiment;

FIG. 3 is a diagram schematically illustrating a display apparatus according to an embodiment;

FIG. 4 is a schematic diagram for describing a demultiplexer according to an embodiment;

FIG. 5 is a timing diagram for describing an operation of the demultiplexer shown in FIG. 4;

FIG. 6 is a schematic diagram for describing a display and a data distributor of the display apparatus shown in FIG. 3;

FIG. 7 is a plan view schematically illustrating sub-pixel circuits and data lines according to an embodiment;

FIG. 8 is a plan view schematically illustrating driving voltage lines and data lines according to an embodiment;

FIG. 9 is a schematic diagram for describing a display and a data distributor of a display apparatus according to an embodiment;

FIG. 10 is a schematic diagram for describing first voltage transfer lines and second voltage transfer lines according to an embodiment;

FIG. 11A is a diagram schematically illustrating a display apparatus according to an embodiment;

FIG. 11B is a schematic diagram for describing a display and a data distributor of the display apparatus shown in FIG. 11A;

FIG. 12A is a diagram schematically illustrating a display apparatus according to an embodiment; and

FIG. 12B is a schematic diagram for describing a display and a data distributor of the display apparatus shown in FIG. 12A.

### DETAILED DESCRIPTION OF THE EMBODIMENTS

In the following description, for the purposes of explanation, numerous specific details are set forth in order to provide a thorough understanding of various embodiments or implementations of the disclosure. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the disclosure. Therefore, unless otherwise specified, the features, components, modules, layers, films, panels, regions, and/or aspects, etc., (hereinafter individually or collectively referred to as “elements”), of the various embodiments may be otherwise combined, separated, interchanged, and/or rearranged without departing from the disclosure.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals and/or reference characters denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the X-axis, the Y-axis, and the Z-axis are not limited to three axes of a rectangular coordinate system, such as the x, y, and z axes, and may be interpreted in a broader sense. For example, the X-axis, the Y-axis, and the Z-axis may be perpendicular to one another, or may be different directions that are not perpendicular to one another.

For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc., may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, parts, and/or modules. Those skilled in the art will appreciate that these blocks, parts, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, parts, and/or modules being implemented by microprocessors or other similar hardware, they may be programmed and controlled using software (e.g., microcode) to perform various functions discussed herein and may optionally be driven by firmware and/or software. It is also contemplated that each block, part, and/or module may be implemented by dedicated hardware, or as a combination of dedicated hardware to perform some functions and a processor (e.g., one or more programmed microprocessors and associated circuitry) to perform other functions. Also, each block, part, and/or module of some embodiments may be physically separated into two or more interacting and discrete blocks, parts, and/or modules without departing from the scope of the disclosure. Further, the blocks, parts, and/or modules of some embodiments may be physically combined into more complex blocks, parts, and/or modules without departing from the scope of the disclosure.

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

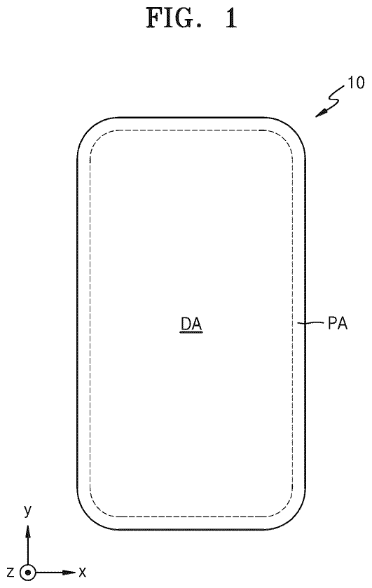

FIG. 1 is a plan view schematically illustrating a display apparatus 10 according to an embodiment.

Referring to FIG. 1, the display apparatus 10 may include a display area DA on which an image is displayed and a peripheral area PA outside the display area DA. The display apparatus 10 may provide a certain image by using light emitted from multiple pixels arranged in the display area DA. Each of the pixels may include one or more sub-pixels. In an embodiment, one pixel may include a first sub-pixel emitting red light, a second sub-pixel emitting green light, and a third sub-pixel emitting blue light.

In a plan view, the display area DA may have a rectangular shape. In an embodiment, the display area DA may have other polygonal shapes, such as a circular shape, an elliptical shape, an irregular shape, or the like. The display area DA may have a shape with round corners.

In an embodiment, the display apparatus 10 may have the display area DA of which a length in a first direction (x-direction) is greater than a length in a second direction (y-direction). In an embodiment, the display apparatus 10 may have the display area DA of which the length in the first direction (x-direction) is less than the length in the second direction (y-direction).

The peripheral area PA, which is an area around the display area DA, may surround at least a part of the display area DA. In an embodiment, the peripheral area PA may be a kind of non-display area in which no pixels are arranged. Various lines for transferring electrical signals to be applied to the display area DA, circuits, and pads to which a printed circuit board or a driver integrated circuit (IC) chip may be attached may be positioned in the peripheral area PA.

The display apparatus 10 according to one or more embodiments may be an apparatus for displaying moving images or still images and may be used as display screens not only for portable electronic devices, such as mobile phones, smartphones, tablet personal computers (PCs), mobile communication terminals, electronic notebooks, electronic books, portable multimedia players (PMPs), navigations, or ultra mobile PCs (UMPCs), but also for various products such as televisions, laptops, monitor, billboards, or Internet-of-Things (IoT) devices. The display apparatus 10 according to an embodiment may be used for wearable devices, such as smart watches, watch phones, glasses-type displays, and head-mounted displays (HMDs). The display apparatus 10 according to an embodiment may be used as instrument panels for a vehicle, center information displays (CIDs) disposed on a center fascia or dashboard of a vehicle, room mirror displays replacing side-view mirrors of a vehicle, or as displays disposed on a rear surface of a front seat for an entertainment for backseat of a vehicle.

Hereinbelow, an organic light-emitting display apparatus may be described as an example of the display apparatus 10 according to an embodiment, but the display apparatus 10 of the disclosure is not limited thereto. In an embodiment, the display apparatus 10 of the disclosure may be a display apparatus such as inorganic light-emitting displays (or inorganic electroluminescent display apparatuses) or quantum dot light-emitting displays.

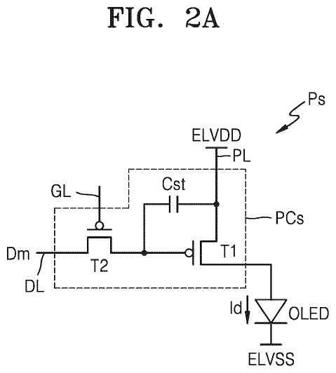

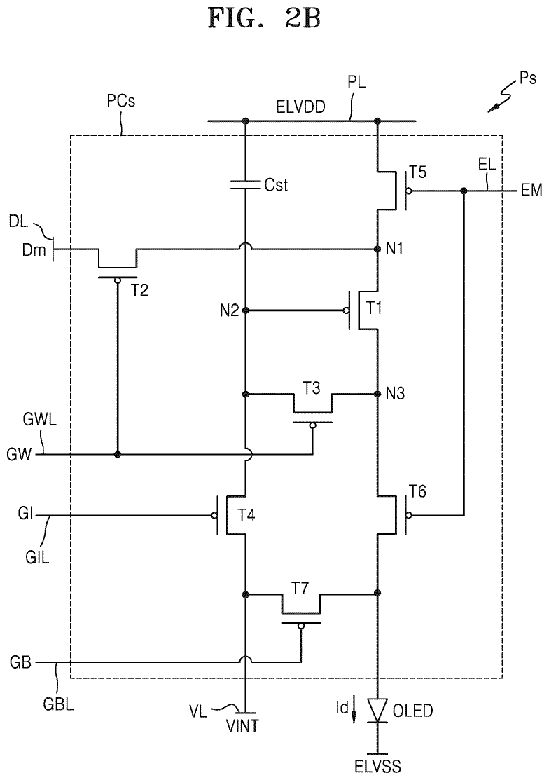

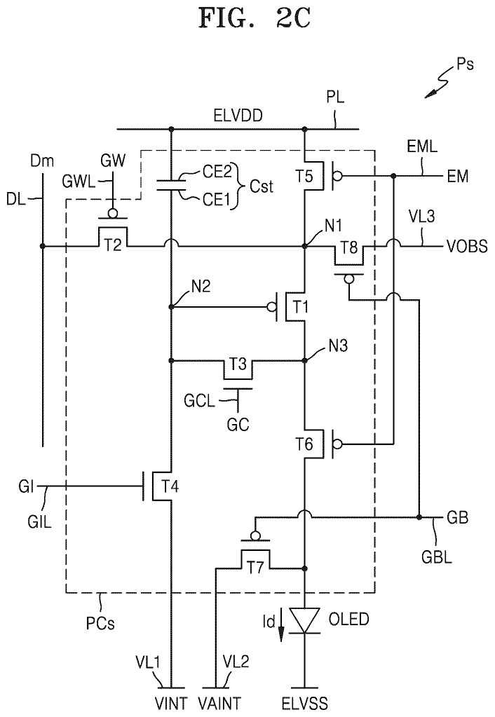

FIGS. 2A to 2C are schematic diagrams of equivalent circuits each illustrating a sub-pixel Ps included in a display apparatus according to an embodiment.

Referring to FIG. 2A, a sub-pixel circuit PCs may be connected to a light-emitting element and may implement light emission of the sub-pixel Ps. The light-emitting element may be an organic light-emitting diode OLED. The sub-pixel circuit PCs may include a first transistor T1, which is a driving transistor, a second transistor T2, which is a switching transistor, and a capacitor Cst. The second transistor T2 may be connected to a gate line GL and a data line DL and may transfer a data signal DATA received via the data line DL to the first transistor T1 in response to a gate signal received via the gate line GL.

The capacitor Cst may be connected to the second transistor T2 and a driving voltage line PL and may store a voltage corresponding to a difference between a voltage received from the switching transistor T2 and a driving voltage ELVDD supplied to the driving voltage line PL.

The first transistor T1 may be connected to the driving voltage line PL and the capacitor Cst and may control a driving current Id flowing from the driving voltage line PL to the organic light-emitting diode OLED in response to a voltage value stored in the capacitor Cst. The organic light-emitting diode OLED may emit light with certain luminance according to the driving current Id.

Referring to FIG. 2B, the sub-pixel circuit PCs may include first to seventh transistor T1 to T7 and a storage capacitor Cst. Depending on a type (p-type or n-type) of a transistor and/or an operating condition, a first terminal of each of the first to seventh transistor T1 to T7 may be a source or drain and a second terminal may be a terminal different from the first terminal. For example, in case that the first terminal is a source, the second terminal may be a drain. The first transistor T1 may be a driving transistor of which a magnitude of source-drain current may be determined according to a gate-source voltage Vgs, and the second to seventh transistors T2 to T7 may be switching transistors that are turned on or off according to a gate-source voltage or gate voltage.

The sub-pixel circuit PCs may be connected to a first gate line GWL configured to transfer a first gate signal GW, a second gate line GIL configured to transfer a second gate signal GI, a third gate line GBL configured to transfer a third gate signal GB, an emission control line EL configured to transfer an emission control signal EM, the data line DL configured to transfer the data signal DATA, the driving voltage line PL configured to transfer a driving voltage ELVDD, and an initialization voltage line VL configured to transfer an initialization voltage VINT.

The first transistor T1 may include a gate connected to a second node N2, a first terminal connected to a first node N1, and a second terminal connected to a third node N3. The first transistor T1 may receive a data signal Dm according to a switching operation of the second transistor T2 and supply a driving current Id to a light-emitting element. The light-emitting element may be the organic light-emitting diode OLED.

The second transistor T2 may include a gate connected to the first gate line GWL, a first terminal connected to the data line DL, and a second terminal connected to the first node N1. The second transistor T2 may be turned on according to the first gate signal GW received via the first gate line GWL and may perform a switching operation for transferring the data signal Dm received via the data line DL to the first node N1.

The third transistor T3 may include a gate connected to the first gate line GWL, a first terminal connected to the second node N2, and a second terminal connected to the third node N3. The third transistor T3 may be turned on according to the first gate signal GW received via the first gate line GWL and may diode-connect the first transistor T1.

The fourth transistor T4 may include a gate connected to the second gate line GIL, a first terminal connected to the initialization voltage line VL, and a second terminal connected to the second node N2. The fourth transistor T4 may be turned on according to the second gate signal GI received via the second gate line GIL and may transfer the initialization voltage VINT to the gate of the first transistor T1 and initialize a gate voltage of the first transistor T1.

The fifth transistor T5 may include a gate connected to the emission control line EL, a first terminal connected to the driving voltage line PL, and a second terminal connected to the first node N1. The sixth transistor T6 may include a gate connected to the emission control line EL, a first terminal connected to the third node N3, and a second terminal connected to a pixel electrode of the organic light-emitting diode OLED. The fifth transistor T5 and the sixth transistor T6 may be simultaneously turned on according to the emission control signal EM received via the emission control signal EL so that the driving current Id flows through the organic light-emitting diode OLED.

The seventh transistor T7 may include a gate connected to the third gate line GBL, a first terminal connected to a second terminal of the sixth transistor T6 and the pixel electrode of the organic light-emitting diode OLED, and a second terminal connected to the initialization voltage line VL. The seventh transistor T7 may be turned on according to the third gate signal GB received via the third gate line GBL and may transfer the initialization voltage VINT to the pixel electrode of the organic light-emitting diode OLED and initialize the pixel electrode of the organic light-emitting diode OLED. The seventh transistor T7 may be omitted.

The storage capacitor Cst may include a first capacitor electrode CE1 connected to the second node N2 and a second capacitor electrode CE2 connected to the driving voltage line PL.

The organic light-emitting diode OLED may include a pixel electrode (e.g., an anode) and a common electrode (e.g., a cathode) facing the pixel electrode, and the common electrode may receive a common voltage ELVSS. The organic light-emitting diode OLED may receive the driving current Id from the first transistor T1 and emit light of a certain color, to display an image.

Referring to FIG. 2C, the sub-pixel circuit PCs may include first to eighth transistors T1 to T8 and the storage capacitor Cst. The first transistor T1 may be a driving transistor in which a magnitude of a source-drain current may be determined according to the gate-source voltage Vgs, and the second to eighth transistors T2 to T8 may be switching transistors each configured to transfer a signal.

The sub-pixel circuit PCs may be connected to the first gate line GWL configured to transfer the first gate signal GW, a second gate line GCL configured to transfer a second gate signal GC, a third gate line GIL configured to transfer a third gate signal GI, a fourth gate line GBL configured to transfer a fourth gate signal GB, an emission control line EML configured to transfer the emission control signal EM, the data line DL configured to transfer the data signal Dm, the driving voltage line PL configured to transfer the driving voltage ELVDD, a first initialization voltage line VL1 configured to transfer a first initialization voltage VINT, a second initialization voltage line VL2 configured to transfer a second initialization voltage VAINT, and a bias voltage line VL3 configured to transfer a bias voltage VOBS.

The first transistor T1 may include a gate connected to a second node N2, a first terminal connected to a first node N1, and a second terminal connected to a third node N3. The first transistor T1 may receive the data signal Dm according to a switching operation of the second transistor T2 and supply the driving current Id to a light-emitting element.

The second transistor T2 may include a gate connected to the first gate line GWL, a first terminal connected to the data line DL, and a second terminal connected to the first node N1. The second transistor T2 may be turned on according to the first gate signal GW received via the first gate line GWL and may perform a switching operation for transferring the data signal Dm received via the data line DL to the first node N1.

The third transistor T3 may include a gate connected to the second gate line GCL, a first terminal connected to the second node N2, and a second terminal connected to the third node N3. The third transistor T3 may be turned on according to the second gate signal GC received via the second gate line GCL and may diode-connect the first transistor T1.

The fourth transistor T4 may include a gate connected to the third gate line GIL, a first terminal connected to the first initialization voltage line VL1, and a second terminal connected to the second node N2. The fourth transistor T4 may be turned on according to the third gate signal GI received via the third gate line GIL and may transfer the initialization voltage VINT to the gate of the first transistor T1 and initialize a gate voltage of the first transistor T1.

The fifth transistor T5 may include a gate connected to the emission control signal EML, a first terminal connected to the driving voltage line PL, and a second terminal connected to the first node N1. The sixth transistor T6 may include a gate connected to the emission control line EML, a first terminal connected to the third node N3, and a second terminal connected to the pixel electrode of the organic light-emitting diode OLED. The fifth transistor T5 and the sixth transistor T6 may be simultaneously turned on according to the emission control signal EM received via the emission control signal EML so that the driving current Id flows through the organic light-emitting diode OLED.

The seventh transistor T7 may include a gate connected to the fourth gate line GBL, a first terminal connected to the second terminal of the sixth transistor T6 and the pixel electrode of the organic light-emitting diode OLED, and a second terminal connected to the second initialization voltage line VL2. The seventh transistor T7 may be turned on according to the fourth gate signal GB received via the fourth gate line GBL and may transfer the second initialization voltage VAINT from the second initialization voltage line VL2 to the pixel electrode of the organic light-emitting diode OLED, to initialize the pixel electrode of the organic light-emitting diode OLED.

The eighth transistor T8 may include a gate connected to the fourth gate line GBL, a first terminal connected to the first node N1, and a second terminal connected to the bias voltage line VL3. The eighth transistor T8 may be turned on according to the fourth gate signal GB received via the fourth gate line GBL and may transfer the bias voltage VOBS from the bias voltage line VL3 to the first node N1.

The storage capacitor Cst may include a first capacitor electrode connected to the second node N2 and a second capacitor electrode connected to the driving voltage line PL.

The organic light-emitting diode OLED may include a pixel electrode (e.g., an anode) and a common electrode (e.g., a cathode) facing the pixel electrode, and the common electrode may receive the common voltage ELVSS. The organic light-emitting diode OLED may receive the driving current Id from the first transistor T1 and emit light of a certain color, to display an image.

In FIGS. 2A and 2B, the transistors of the sub-pixel circuit PCs may be P-type transistors. However, one or more embodiments are not limited thereto. For example, the transistors of the sub-pixel circuit PCs may be N-type transistors, and as shown in FIG. 2C, some transistors may be P-type transistors and other transistors may be N-type transistors. For example, the third transistor T3 and the fourth transistor T4 may be N-type transistors, and the remaining transistors may be P-type transistors. The sub-pixel circuits PCs of FIGS. 2A to 2C may be examples, and various design changes may be made to the sub-pixel circuit PCs of the disclosure.

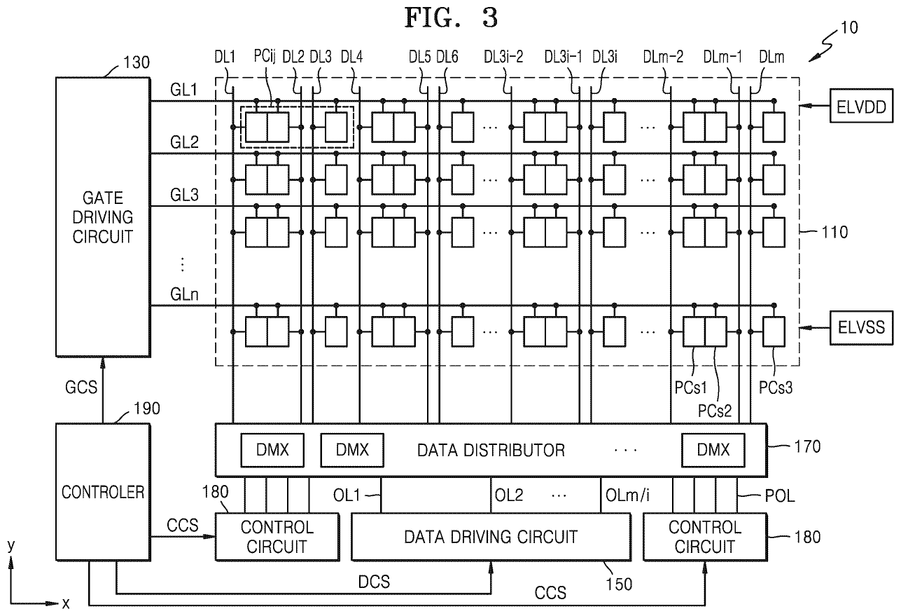

FIG. 3 is a diagram schematically illustrating the display apparatus 10 according to an embodiment.

Referring to FIG. 3, the display apparatus 10 may include a display 110 (e.g., pixel portion), a gate driving circuit 130, a data driving circuit 150, a data distributor 170, control circuits 180, and a controller 190.

The display 110 in which multiple pixel circuits PCij may be arranged may be provided in the display area DA (see FIG. 1). The gate driving circuit 130, the data driving circuit 150, the data distributor 170, the control circuits 180, and the controller 190 may be provided in the peripheral area PA (see FIG. 1).

In an embodiment, the gate driving circuit 130 and the data distributor 170 may be formed directly on a substrate. The data driving circuit 150, the control circuit 180, and the controller 190 may be disposed on a flexible printed circuit board (FPCB), which is electrically connected to a pad arranged on a side (e.g., single side) of the substrate. In an embodiment, the data driving circuit 150 and the control circuit 180 may be disposed directly on the substrate by using a chip on glass (COG) or chip on plastic (COP) method.

Each pixel circuit PCij may include multiple sub-pixel circuits PCs. For example, a pixel circuit (e.g., single pixel circuit) PCij may include a first sub-pixel circuit PCs1, a second sub-pixel circuit PCs2, and a third sub-pixel circuit PCs3.

Each of the sub-pixel circuits PCs may be connected to a corresponding gate line of multiple gate lines GL1 to GLn and a corresponding data line of multiple data lines DL1 to DLm. The gate lines GL1 to GLn may each extend in the first direction (e.g., x-direction, row direction) and may be connected to the sub-pixel circuits in the same row. The gate lines GL1 to GLn may each transfer a gate signal to the sub-pixel circuits PCs in the same row. The data lines DL1 to DLm (DL1, DL2, DL3, DL4, DL5, DL6, . . . , DL3i-2, DL3i-1, DL3i, . . . , DLm−2, DLm−1, DLm of FIG. 3) may each extend in the second direction (e.g., the y-direction, column direction) and may be connected to the sub-pixel circuits in the same column. Hereinbelow, in case that it is referred that a line is connected to a sub-pixel circuit row or sub-pixel circuit column, it means that the line may be connected to sub-pixel circuits in the corresponding row or column.

The gate driving circuit 130 may be connected to the gate lines GL1 to GLn and may generate gate signals in response to a gate driving control signal GCS from the controller 190 and sequentially supply the generated gate signals to the gate lines GL1 to GLn. In case that the gate signals are sequentially supplied to the gate lines GL1 to GLn, the sub-pixel circuit PCs may be selected row by row. The data lines DL1 to DLm may be configured to transfer data signals to a selected sub-pixel circuit row. A gate line may be connected to a gate of a transistor included in the sub-pixel circuit PCs. A gate signal may be a gate control signal for controlling a turn-on or turn-off of the transistor connected to the gate line. The gate signal may be a square wave signal in which an on voltage at which a transistor may be turned on and an off voltage at which a transistor may be turned off are repeated.

The data driving circuit 150 may be connected to multiple data output lines OL1 to OLm/i, and the data output lines OL1 to OLm/i may be connected to the data lines DL1 to DLm through the data distributor 170. The data driving circuit 150 may convert an image signal into a data signal in the form of voltage or current according to a data driving control signal DCS received from the controller 190. The data driving circuit 150 may supply the data signal to the data distributor 170 through the data output lines OL1 to OLm/i.

The control circuits 180 may be connected to multiple power output lines POL, and the power output lines POL may be connected to the data distributor 170. The control circuits 180 may supply control signals of sub-demultiplexer DMX to the data distributor 170 through the power output lines POL according to a distribution control signal CCS received from the controller 190.

The data distributor 170 may be connected between the data output lines OL1 to OLm/i and the data lines DL1 to DLm. The data distributor 170 may include an m/i sub-demultiplexers DMX (i may be a natural number of 2 or more) including multiple switches.

In other words, the data distributor 170 may have the same number of sub-demultiplexers DMX as the number of data output lines. An end of the sub-demultiplexer DMX may be connected to a data output line from among the data output lines OL1 to OLm/i. Another end of the sub-demultiplexer DMX may be connected to i data lines. The sub-demultiplexer DMX may supply a data signal received from the corresponding data output line to the i data lines. In case that the sub-demultiplexer DMX is used, fewer data output lines OL1 to OLm/i may be required than the number of data lines DL1 to DLm, and thus, the number of data output lines connected to the data driving circuit 150 may be reduced, thereby reducing manufacturing costs. The sub-demultiplexer DMX may include multiple switches each connected to the corresponding data output line and respectively connected to the i data lines. In an embodiment, i may be 2.

The controller 190 may generate the data driving control signal DCS, the gate driving control signal GCS, and the distribution control signal CCS in response to synchronization signals received from the outside. The controller 190 may output the data driving control signal DCS to the data driving circuit 150 and the gate driving control signal GCS to the gate driving circuit 130. The controller 190 may output the distribution control signal CCS to the control circuits 180, and the control circuits 180 may output control signals of the sub-demultiplexers DMX in response to the distribution control signal CCS. The data distributor 170 may selectively connect the data output lines OL1 to OLm/i and the data lines DL1 to DLm to each other in response to the control signals of the sub-demultiplexers DMX.

In case that the display apparatus 10 is an organic light-emitting display apparatus, the driving voltage ELVDD and the common voltage ELVSS may be supplied to the sub-pixel circuit PCs and the organic light-emitting diode OLED (see FIGS. 2A to 2C) of the display apparatus 10. The driving voltage ELVDD may be a high-level voltage provided to a first electrode (pixel electrode or anode electrode) of each organic light-emitting diode OLED. The common voltage ELVSS may be a low-level voltage provided to a second electrode (opposite electrode or cathode electrode) of each organic light-emitting diode OLED.

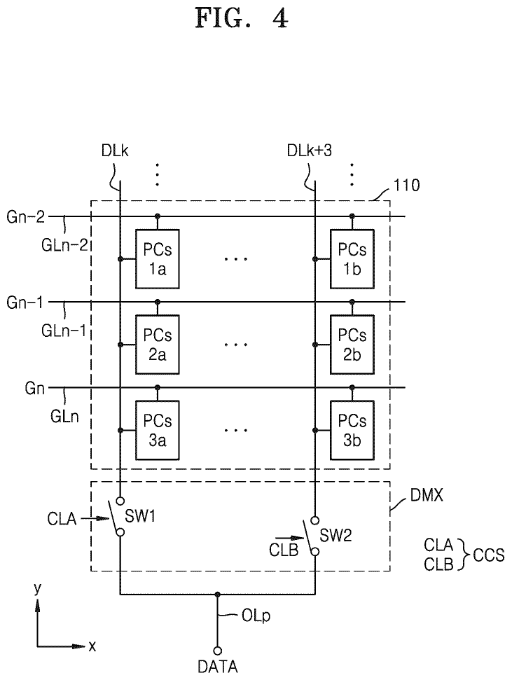

FIG. 4 is a schematic diagram for describing a demultiplexer according to an embodiment.

Referring to FIG. 4, the sub-demultiplexer DMX may selectively connect a pth data output line OLp to a pair of kth data line DLk and (k+3)th data lines DLk+3. The sub-demultiplexer DMX may include a first switch SW1 and a second switch SW2.

The kth data line DLk and the (k+3)th data lines DLk+3 may be data lines spaced apart from each other by three columns. For example, a (k+1)th data line and a (k+2)th data line may be disposed between the kth data line DLk and the (k+3)th data lines DLk+3. The kth data line DLk may be connected to a kth sub-pixel circuit column and the (k+3)th data lines DLk+3 may be connected to a (k+3)th sub-pixel circuit column.

The distribution control signals CCS of the sub-demultiplexer DMX output from the control circuit 180 (see FIG. 3) may include a first control signal CLA and a second control signal CLB. The first control signal CLA and the second control signal CLB may be alternately applied at different timings so as not to overlap each other.

The first switch SW1 may be provided between the pth data output line OLp and the kth data line DLk. The first switch SW1 may connect the pth data output line OLp and the kth data line DLk to each other according to the first control signal CLA and apply the data signal DATA received via the pth data output line OLp to the kth data line DLk.

The second switch SW2 may be provided between the pth data output line OLp and the (k+3)th data lines DLk+3. The second switch SW2 may connect the pth data output line OLp and the (k+3)th data lines DLk+3 to each other according to the second control signal CLB and apply the data signal DATA received via the pth data output line OLp to the (k+3)th data lines DLk+3.

In an embodiment, sub-pixels connected to the kth data line DLk and the (k+3)th data lines DLk+3 may be sub-pixels emitting light of the same color. In an embodiment, sub-pixels connected to the kth data line DLk and the (k+3)th data lines DLk+3 may include sub-pixels emitting light of a first color and sub-pixels emitting light of a second color, which is different from the first color, and sub-pixels connected to the (k+1)th data line and a (k+4)th data line may be sub-pixels emitting light of a third color.

Gate lines GLn−2, GLn−1, and GLn shown in FIG. 4 may correspond to the gate line GL shown in FIG. 2A or the first gate lines GWL shown in FIGS. 2B and 2C.

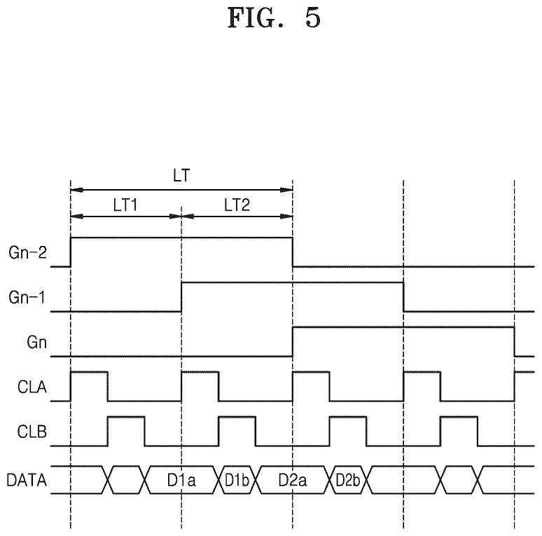

FIG. 5 is a timing diagram for describing an operation of the demultiplexer shown in FIG. 4.

Referring to FIGS. 4 and 5, the first control signal CLA and the second control signal CLB may be supplied from the control circuit 180 (see FIG. 3) to the sub-demultiplexer DMX through the power output line POL (see FIG. 3).

The first control signal CLA and the second control signal CLB may be a square wave signal in which an on voltage at which the first switch SW1 and the second switch SW2 may be turned on and an off voltage at which the first switch SW1 and the second switch SW2 may be turned off may be repeated. In an embodiment, the on-voltage of the first control signal CLA and the second control signal CLB may be a high-level voltage (first-level voltage), and the off-voltage may be a low-level voltage (second-level voltage).

The first control signal CLA and the second control signal CLB may have the same waveform and may be signals of which phases may be shifted. For example, timings at which voltage levels of the first control signal CLA and the second control signal CLB may be inverted may be the same. A period in which an on-voltage of the first control signal CLA may be maintained (hereinafter, referred to as “on-voltage period”) may overlap a period in which an off-voltage of the second control signal CLB may be maintained (hereinafter, referred to as “off-voltage period”), and an off-voltage period of the first control signal CLA may overlap an on-voltage period of the second control signal CLB.

During a frame (e.g., single frame), gate signals Gn−2, Gn−1, and Gn may be sequentially supplied with an on-voltage from the gate driving circuit 130 (see FIG. 3) through the gate lines GLn−2, GLn−1, and GLn, respectively. The gate signals Gn−2, Gn−1, and Gn may be gate signals for controlling turn-on and turn-off of a data write transistor (e.g., the second transistor T2). The gate signals Gn−2, Gn−1, and Gn may be supplied with an on-voltage at which the data write transistor may be turned on and with an off-voltage at which the data write transistor may be turned off. In an embodiment, the on-voltages of the gate signals Gn−2, Gn−1, and Gn may be high-level voltages (first-level voltages), and the off-voltages may be low-level voltages (second-level voltages).

The on-voltage period of the gate signals Gn−2, Gn−1, and Gn may be a line time LT. The line time LT may be a time required to write the data signal DATA to a sub-pixel circuit row in the display apparatus 10 (see FIG. 1). In an embodiment, the line time LT may be approximately 2 H. The line time LT may include a first sub-line time LT1 and a second sub-line time LT2 that follows the first sub-line time LT1. Each of the first and second sub-line times LT1 and LT2 may be approximately 1 H. The first sub-line time LT1 of a current gate signal may overlap the second sub-line time LT2 of the previous gate signal.

The on-voltage of the first control signal CLA and the on-voltage of the second control signal CLB may be alternately supplied to the sub-demultiplexer DMX for each of the first and second LT1 and LT2. For example, the first control signal CLA may be supplied with an on-voltage for each of the first sub-line time LT1 and the second sub-line time LT2 of a line time of a row in which a gate signal may be supplied (hereinafter, referred to as “current line time”), and then the first control signal CLA may transition to an off-voltage so that the second control signal CLB may be supplied with an on-voltage.

A data signal supplied during the first sub-line time LT1 may be a data signal of the previous line time corresponding to a row in which the previous gate signal may be supplied (previous line), and a data signal supplied during the second sub-line time LT2 may be a data signal of a current line time corresponding to a row in which a current gate signal may be supplied (current line). In other words, during the second sub-line time LT2, the data signal DATA corresponding to the current line time may be written to the sub-pixel circuits PCs of the current line.

The data driving circuit 150 (see FIG. 2) may be synchronized with the control signals CLA and CLB and may supply the data signal DATA to the data output line OLp.

The first sub-line time LT1 of the (n−1)th gate signal Gn−1 may overlap the second sub-line time LT2 of the (n−2)th gate signal Gn−2. Accordingly, during the first sub-line time LT1 of the (n−1)th gate signal Gn−1, data write transistors of sub-pixel circuits PCs1a and PCs1b connected to the (n−2)th gate line GLn−2 and sub-pixel circuits PCs2a and PCs2b connected to the (n−1)th gate line GLn−1 may be turned on.

The first control signal CLA may be first supplied with an on-voltage to the first switch SW1 of the sub-demultiplexer DMX during the first sub-line time LT1 of the (n−1)th gate signal Gn−1. Accordingly, a data signal D1a may be supplied to the sub-pixel circuits PCs1a and PCs2a connected to a data line DLk to which the first switch SW1 may be connected from among the sub-pixel circuits PCs1a and PCs1b connected to the (n−2)th gate line GLn−2 and the sub-pixel circuits PCs2a and PCs2b connected to the (n−1)th gate line GLn−1.

Thereafter, the second control signal CLB may be supplied to the second switch SW2 of the sub-demultiplexer DMX. Accordingly, a data signal D1b may be supplied to the sub-pixel circuits PCs1b and PCs2b connected to a data line DLk+3 to which the second switch SW2 may be connected from among the sub-pixel circuits PCs1a and PCs1b connected to the (n−2)th gate line GLn−2 and the sub-pixel circuits PCs2a and PCs2b connected to the (n−1)th gate line GLn−1.

The second sub-line time LT2 of the (n−1)th gate signal Gn−1 may overlap the first sub-line time LT1 of the n^{th} gate signal Gn. Accordingly, during the second sub-line time LT2 of the (n−1)th gate signal Gn−1, data write transistors of the sub-pixel circuits PCs2a and PCs2b connected to the (n−1)th gate line GLn−1 and sub-pixel circuits PCs3a and PCs3b connected to the n^{th} gate line GLn may be turned on.

The first control signal CLA may be first supplied to the first switch SW1 of the sub-demultiplexer DMX during the second sub-line time LT2 of the (n−1)th gate signal Gn−1. Accordingly, a data signal D2a may be supplied to the sub-pixel circuits PCs2a and PCs3a connected to the data line DLk to which the first switch SW1 is connected from among the sub-pixel circuits PCs2a and PCs2b connected to the (n−1)th gate line GLn−1 and the sub-pixel circuits PCs3a and PCs3b connected to the n^{th} gate line GLn.

Thereafter, the second control signal CLB may be supplied to the second switch SW2 of the sub-demultiplexer DMX. Accordingly, a data signal D2b may be supplied to the sub-pixel circuits PCs2b and PCs3b connected to the data line DLk+3 to which the second switch SW2 may be connected from among the sub-pixel circuits PCs2a and PCs2b connected to the (n−1)th gate line GLn−1 and the sub-pixel circuits PCs3a and PCs3b connected to the n^{th} gate line GLn.

A data signal of the previous line time written to the sub-pixel circuits PCs during the first sub-line time LT1 may be overwritten by a data signal of the current line time written to the sub-pixel circuits PCs during the second sub-line time LT2. In this manner, the data driving circuit 150 may write data to all sub-pixel circuits in a row during a single line time LT.

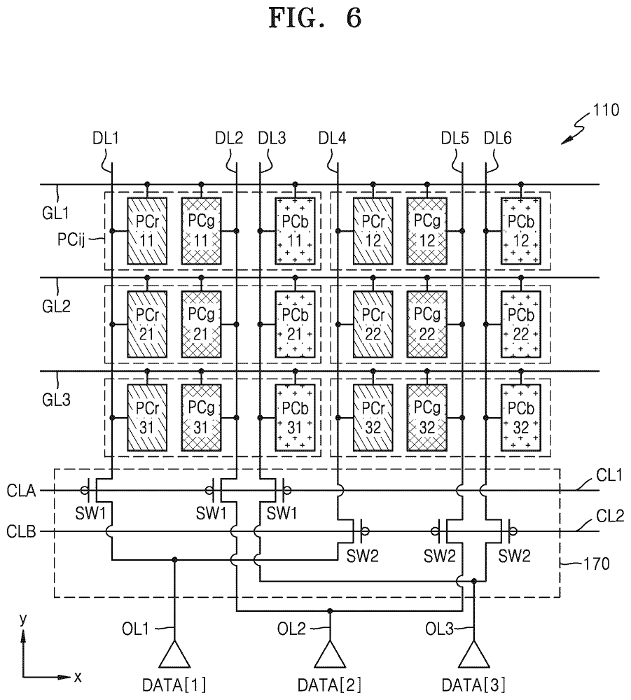

FIG. 6 is a schematic diagram for describing the display 110 and the data distributor 170 of the display apparatus 10 shown in FIG. 3.

The data distributor 170 may include the first switches SW1 and the second switches SW2, and the display 110 may include the pixel circuits PC. A single pixel circuit PCij may include a red sub-pixel circuit PCr, a green sub-pixel circuit PCg, and a blue sub-pixel circuit PCb. The sub-pixel circuits PCr, PCg, and PCb may be repeatedly arranged in the first direction (x-axis direction, row direction) and the second direction (y-axis direction, column direction).

A column in which the red sub-pixel circuits PCr may be arranged in the second direction (y-axis direction), a column in which the green sub-pixel circuits PCg may be arranged in the second direction (y-axis direction), and a column in which the blue sub-pixel circuits PCb may be arranged in the second direction (y-axis direction) may be alternately repeated in the first direction (e.g., the x-axis direction).

Multiple data lines DL1, DL2, . . . , DL6 and multiple gate lines GL1, GL2, and GL3 may be arranged in the display 110. The gate lines GL1, GL2, and GL3 may correspond to the gate line GL shown in FIG. 2A or the first gate line GWL shown in FIGS. 2B and 2C.

A gate line may be connected to sub-pixel circuits arranged in the same row. A data line may be connected to sub-pixel circuits arranged in the same column. Sub-pixels connected to an i^{th} data line DLi and sub-pixels connected to an (i+3)th data line DLi+3 may be sub-pixels emitting light of the same color. For example, sub-pixel circuit columns respectively connected to the first data line DL1 and the fourth data line DL4 may include the red sub-pixel circuits PCr, sub-pixel circuit columns respectively connected to the second data line DL2 and the fifth data line DL5 may include the green sub-pixel circuits PCg, and sub-pixel circuit columns respectively connected to the third data line DL3 and the sixth data line DL6 may include the blue sub-pixel circuits PCb.

In FIG. 6, for convenience of description, only six data lines DL1, DL2, . . . , DL6, three gate lines GL1, GL2, and GL3, and three data output lines OL1, OL2, and OL3 may be shown. However, the number of data lines, gate lines, and data output lines may be greater.

The data distributor 170 may selectively connect the data output lines OL1, OL2, and OL3 to one of a pair of corresponding data lines. For example, the data distributor 170 may selectively connect the first data output line OL1 to one of the first data line DL1 and the fourth data line DL4, selectively connect the second data output line OL2 to one of the second data line DL2 and the fifth data line DL5, and selectively connect the third data output line OL3 to one of the third data line DL3 and the sixth data line DL6.

The first switches SW1 may be respectively provided between the first data output line OL1 and the first data line DL1, between the second data output line OL2 and the second data line DL2, and between the third data output line OL3 and the third data line DL3. The first switches SW1 may be turned on according to the first control signal CLA and may connect the first data output line OL1 and the first data line DL1 to each other, connect the second data output line OL2 and the second data line DL2 to each other, and connect the third data output line OL3 and the third data line DL3 to each other.

The second switches SW2 may be respectively provided between the first data output line OL1 and the fourth data line DL4, between the second data output line OL2 and the fifth data line DL5, and between the third data output line OL3 and the sixth data line DL6. The second switches SW2 may be turned on according to the second control signal CLB and may connect the first data output line OL1 and the fourth data line DLA to each other, connect the second data output line OL2 and the fifth data line DL5 to each other, and connect the third data output line OL3 and the sixth data line DL6 to each other.

The control circuit 180 (see FIG. 3) may supply the first control signal CLA to the first switches SW1 through a first control signal line CL1 and supply the second control signal CLB to the second switches SW2 through a second control signal line CL2, where the first control signal line CL1 and the second control signal line CL2 are electrically connected to the power output lines POL. In an embodiment, the first switches SW1 and the second switches SW2 may be switching transistors that are turned on or turned off according to a gate voltage. The first control signal line CL1 may be connected to a gate electrode of each of the first switches SW1, and the second control signal line CL2 may be connected to a gate electrode of each of the second switches SW2.

The first data line DL1 and the second data line DL2 neighboring each other may receive data signals according to the same control signal. In other words, the first data line DL1 may be connected to the first data output line OL1 by the first control signal CLA and may receive a first data signal DATA [1], and the second data line DL2 may be connected to the second data output line OL2 by the first control signal CLA and may receive a second data signal DATA [2]. Here, the two data lines neighboring each other indicate that no other data line may be disposed between the two data lines.

The third data line DL3 and the fourth data line DLA neighboring each other may receive data signals according to different control signals. In other words, the third data line DL3 may be connected to the third data output line OL3 by the first control signal CLA and may receive a third data signal DATA [3], and the fourth data line DL4 may be connected to the first data output line OL1 by the second control signal CLB and may receive the first data signal DATA [1].

The fifth data line DL5 and the sixth data line DL6 neighboring each other may receive data signals according to the same control signal. In other words, the fifth data line DL5 may be connected to the second data output line OL2 by the second control signal CLB and may receive the second data signal DATA [2], and the sixth data line DL6 may be connected to the third data output line OL3 by the second control signal CLB and may receive the third data signal DATA [3].

The third data line DL3 and the fourth data line DL4 receiving the data signals according to the different control signals may be arranged apart from each other with third sub-pixel circuit columns PCb11, PCb21, and PCb31 therebetween, the third sub-pixel circuit columns PCb11, PCb21, and PCb31 being connected to the third data line DL3. Here, in case that two data lines are arranged apart from each other with a sub-pixel circuit column therebetween, it means that driving transistors (first transistor T1 (see FIGS. 2A to 2C)) included in the sub-pixel circuit column may be disposed between the two data lines.

The fifth data line DL5 and the sixth data line DL6 receiving the data signals according to the same control signal may be arranged to face each other. Here, in case that two data lines are arranged to face each other, it means that the two data lines are disposed between sub-pixel circuit columns respectively connected thereto, and are arranged directly adjacent to each other.

Each of the data lines DL1, DL2, . . . , DL6 may be arranged on a first side or second side of a sub-pixel circuit column connected thereto. Herein, the first side of a sub-pixel circuit column refers to a-x direction (left side) with respect to the center of the sub-pixel circuit column, and the second side refers to a +x direction (right side) with respect to the center of the sub-pixel circuit column.

The first data line DL1 may be connected to first sub-pixel circuit columns PCr11, PCr21, and PCr31 and arranged on first sides of the first sub-pixel circuit columns PCr11, PCr21, and PCr31, and the second data line DL2 may be connected to second sub-pixel circuit columns PCg11, PCg21, and PCg31 and arranged on second sides of the second sub-pixel circuit columns PCg11, PCg21, and PCg31.

The third data line DL3 may be connected to the third sub-pixel circuit columns PCb11, PCb21, and PCb31 and arranged on first sides of the third sub-pixel circuit columns PCb11, PCb21, and PCb31, and the fourth data line DLA may be connected to fourth sub-pixel circuit columns PCr12, PCr22, and PCr32 and arranged on first sides of the fourth sub-pixel circuit columns PCr12, PCr22, and PCr32.

The fifth data line DL5 may be connected to fifth sub-pixel circuit columns PCg12, PCg22, and PCg32 and arranged on second sides of the fifth sub-pixel circuit columns PCg12, PCg22, and PCg32, and the sixth data line DL6 may be connected to sixth sub-pixel circuit columns PCb12, PCb22, and PCb32 and arranged on first sides of the sixth sub-pixel circuit columns PCb12, PCb22, and PCb32.

In an embodiment, sub-pixel circuits belonging to the first sub-pixel circuit columns PCr11, PCr21, and PCr31 may have a symmetrical shape with sub-pixel circuits belonging to the second sub-pixel circuit columns PCg11, PCg21, and PCg31. The first sub-pixel circuit columns PCr11, PCr21, and PCr31 and the second sub-pixel circuit columns PCg11, PCg21, and PCg31 may overlap a driving voltage line (e.g., single driving voltage line). Sub-pixel circuits belonging to the fourth sub-pixel circuit columns PCr12, PCr22, and PCr32 may have a symmetrical shape with sub-pixel circuits belonging to the fifth sub-pixel circuit columns PCg12, PCg22, and PCg32. The fourth sub-pixel circuit columns PCr12, PCr22, and PCr32 and the fifth sub-pixel circuit columns PCg12, PCg22, and PCg32 may overlap a driving voltage line (e.g., single driving voltage line). According to embodiments, the sub-pixel circuits in the second sub-pixel circuit columns PCg11, PCg21, and PCg31 and the fifth sub-pixel circuit columns PCg12, PCg22, and PCg32 may be flipped so that the first sub-pixel circuit columns PCr11, PCr21, and PCr31 and the second sub-pixel circuit columns PCg11, PCg21, and PCg31 share a driving voltage line (e.g., single driving voltage line) and the fourth sub-pixel circuit columns PCr12, PCr22, and PCr32 and the fifth sub-pixel circuit columns PCg12, PCg22, and PCg32 share a driving voltage line (e.g., single driving voltage line). Accordingly, an area required by the pixel circuit PCij may be reduced.

In a comparative example, in case that two data lines neighboring each other and receiving data signals according to different control signals are arranged to face each other, coupling may occur between the two data lines. Accordingly, a potential of a data signal receiving a data signal according to a first control signal from among the two data lines may be changed by a potential of a data line receiving a data signal according to a second control signal. Accordingly, in embodiments, the two data lines DL3 and DLA neighboring each other and receiving data signals according to different control signals may be arranged apart from each other with at least one sub-pixel circuit column therebetween, thereby reducing or preventing coupling between the data lines.

The data lines DL5 and DL6 neighboring each other and receiving data signals according to the same control signal each receive a data signal even in case that the data lines DL5 and DL6 are connected to each other, and thus may be immediately restored to a corresponding data potential.

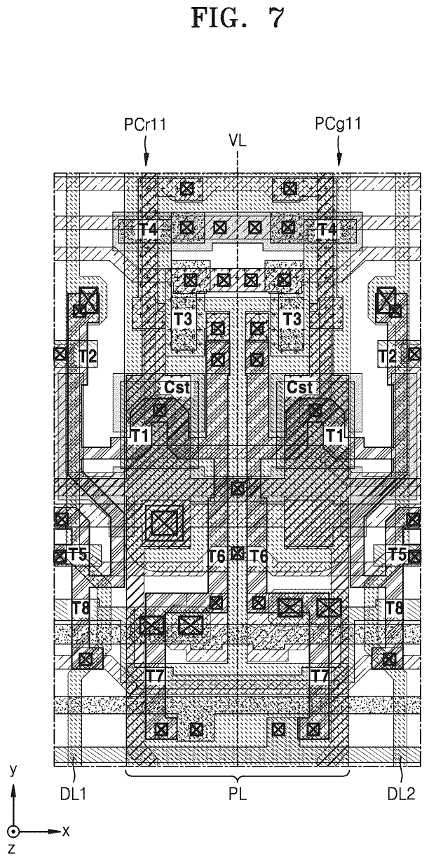

FIG. 7 is a plan view schematically illustrating sub-pixel circuits and data lines according to an embodiment.

Referring to FIG. 7, the display apparatus 10 (see FIG. 1) may include a [1,1]^{th} red sub-pixel circuit PCr11 and a [1,1]^{th} green sub-pixel circuit PCg11, which are arranged adjacent to each other in the first direction (x-axis direction). The [1,1]^{th} red sub-pixel circuit PCr11 and the [1,1]^{th} green sub-pixel circuit PCg11 may each include the first to eighth transistors T1 to T8 and the storage capacitor Cst.

The first data line DL1 may be connected to the second transistor T2 of the [1,1]^{th} red sub-pixel circuit PCr11, and the second data line DL2 may be connected to the second transistor T2 of the [1,1]^{th} green sub-pixel circuit PCg11. The first data line DL1 may be connected to a side (left side) of the [1,1]^{th} red sub-pixel circuit PCr11, and the second data line DL2 may be connected to a second side (right side) of the [1,1]^{th} green sub-pixel circuit PCg11.

In other words, the [1,1]^{th} red sub-pixel circuit PCr11 and the [1,1]^{th} green sub-pixel circuit PCg11 may be disposed between the first data line DL1 and the second data line DL2. As described above, in case that the [1,1]^{th} red sub-pixel circuit PCr11 and the [1,1]^{th} green sub-pixel circuit PCg11 are disposed between the first data line DL1 and the second data line DL2, it means that the first transistor T1 of the [1,1]^{th} red sub-pixel circuit PCr11 and the first transistor T1 of the [1,1]^{th} green sub-pixel circuit PCg11 may be disposed between the first data line DL1 and the second data line DL2. The [1,1]^{th} red sub-pixel circuit PCr11 and the [1,1]^{th} green sub-pixel circuit PCg11 may have an axial symmetric shape with an imaginary straight line VL as an axis of symmetry, the virtual straight line VL extending in the second direction (y-axis direction) along a boundary between the two sub-pixel circuits.

The driving voltage line PL may be connected to a capacitor electrode of the storage capacitor Cst of each sub-pixel circuit and may be configured to transfer the driving voltage ELVDD (see FIGS. 2A to 2C). In case that the [1,1]^{th} green sub-pixel circuit PCg11 is flipped, the two sub-pixel circuits PCr11 and PCg11 disposed between the first data line DL1 and the second data line DL2 may share a driving voltage line PL (e.g., single driving voltage line). Accordingly, an area required by each sub-pixel circuit may be reduced compared to in case that a driving voltage line is arranged for each sub-pixel circuit.

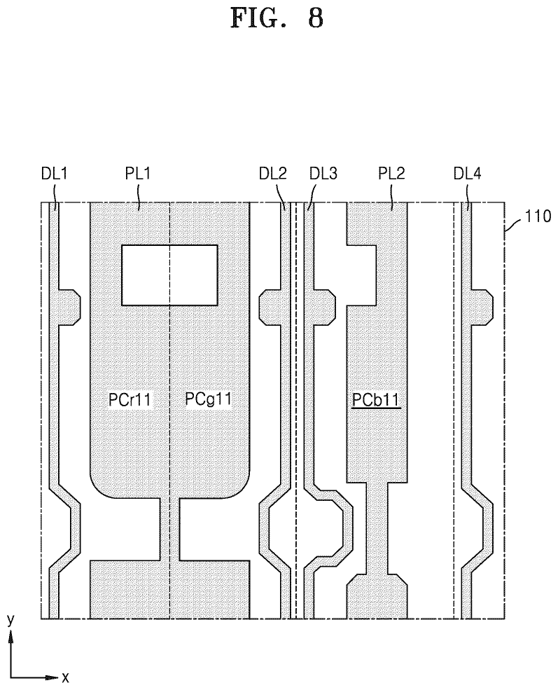

FIG. 8 is a plan view schematically illustrating driving voltage lines and data lines according to an embodiment.

Referring to FIG. 8, the display 110 may include the sub-pixel circuits PCr11, PCg11, and PCb11, the driving voltage lines PL1 and PL2, and the data lines DL1, DL2, DL3, and DL4. The driving voltage lines PL1 and PL2 may extend in the second direction (y-axis direction) and may be arranged to overlap the sub-pixel circuits PCr11, PCg11, and PCb11. The data lines DL1, DL2, DL3, and DL4 may extend in the second direction (y-axis direction) and may be respectively arranged on a side of the sub-pixel circuits PCr11, PCg11, and PCb11.

The first data line DL1 may be connected to [1,1]^{th} red sub-pixel circuit PCr11 and arranged on the first side of the [1,1]^{th} red sub-pixel circuit PCr11. The second data line DL2 may be connected to the [1,1]^{th} green sub-pixel circuit PCg11 and arranged on the second side of the [1,1]^{th} green sub-pixel circuit PCg11. The [1,1]^{th} red sub-pixel circuit PCr11 and the [1,1]^{th} green sub-pixel circuit PCg11 disposed between the first data line DL1 and the second data line DL2 may overlap the first driving voltage line PL1. The first driving voltage line PL1 may be configured to transfer the driving voltage ELVDD (see FIGS. 2A to 2C) to the [1,1]^{th} red sub-pixel circuit PCr11 and the [1,1]^{th} green sub-pixel circuit PCg11.

The third data line DL3 may be connected to the [1,1]^{th} blue sub-pixel circuit PCb11 and arranged on a first side of the [1,1]^{th} blue sub-pixel circuit PCb11. The fourth data line DL4 may be connected to a [1,2]^{th} red sub-pixel circuit PCr12 and arranged on a first side of the [1,2]^{th} red sub-pixel circuit PCr12.

As described with reference to FIG. 6, the first data line DL1, the second data line DL2, and the third data line DL3 may receive data signals according to the first control signal CLA, and the fourth data line DL4 may receive a data signal according to the second control signal CLB. Accordingly, the third data line DL3 and the fourth data line DL4 may be arranged apart from each other with the [1,1]^{th} blue sub-pixel circuit PCb11 therebetween, so as to prevent, or reduce, coupling. The second driving voltage line PL2 disposed between the third data line DL3 and the fourth data line DL4 may overlap the [1,1]^{th} blue sub-pixel circuit PCb11.

In an embodiment, the driving voltage lines PL1 and PL2 and the data lines DL1, DL2, and DL3 may be coplanar with each other. Herein, coplanar elements may be formed by the same process and have a same material, layer structure, and characteristics.

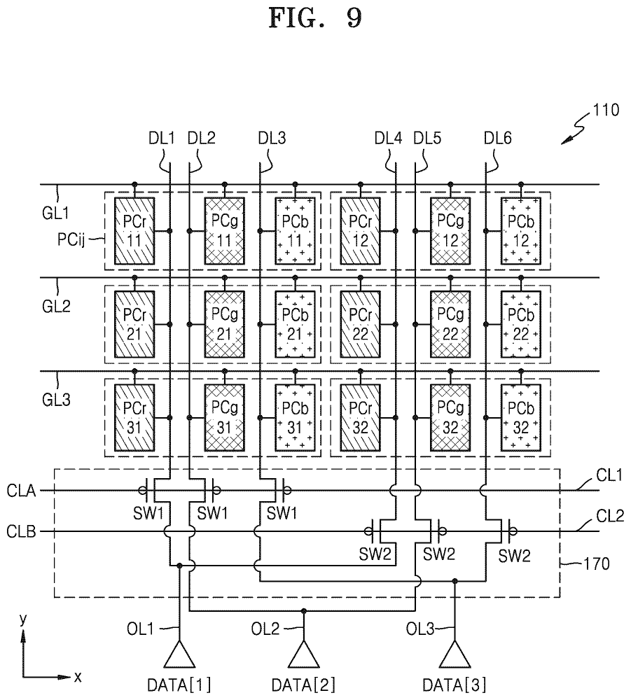

FIG. 9 is a schematic diagram for describing the display 110 and the data distributor 170 of a display apparatus according to an embodiment.

FIG. 9 is similar to FIG. 6, but differs from FIG. 6 with respect to the arrangement of sub-pixel circuits and data lines. Hereinbelow, descriptions of the same or similar elements are omitted, and differences are mainly described.

The data distributor 170 may include the first switches SW1 and the second switches SW2, and the display 110 may include the pixel circuits PC. A single pixel circuit PCij may include the red sub-pixel circuit PCr, the green sub-pixel circuit PCg, and the blue sub-pixel circuit PCb. The sub-pixel circuits PCr, PCg, and PCb may be repeatedly arranged in the first direction (x-axis direction, row direction) and the second direction (y-axis direction, column direction).

A column in which the red sub-pixel circuits PCr may be arranged in the second direction (y-axis direction), a column in which the green sub-pixel circuits PCg may be arranged in the second direction (y-axis direction), and a column in which the blue sub-pixel circuits PCb may be arranged in the second direction (y-axis direction) may be alternately repeated in the first direction (e.g., the x-axis direction).

The data distributor 170 may selectively connect the data output lines OL1, OL2, and OL3 to one of a pair of corresponding data lines. The first switches SW1 may be respectively provided between the first data output line OL1 and the first data line DL1, between the second data output line OL2 and the second data line DL2, and between the third data output line OL3 and the third data line DL3. The second switches SW2 may be respectively provided between the first data output line OL1 and the fourth data line DL4, between the second data output line OL2 and the fifth data line DL5, and between the third data output line OL3 and the sixth data line DL6.

The control circuit 180 (see FIG. 3) may supply the first control signal CLA to the first switches SW1 through a first control signal line CL1 and supply the second control signal CLB to the second switches SW2 through a second control signal line CL2.

The first data line DL1 may be connected to the first data output line OL1 according to the first control signal CLA and may receive the first data signal DATA [1], the second data line DL2 may be connected to the second data output line OL2 according to the first control signal CLA and may receive the second data signal DATA [2], and the third data line DL3 may be connected to the third data output line OL3 according to the first control signal CLA and may receive the third data signal DATA [3]. The fourth data line DL4 may be connected to the first data output line OL1 according to the second control signal CLB and may receive the first data signal DATA [1], the fifth data line DL5 may be connected to the second data output line OL2 according to the second control signal CLB and may receive the second data signal DATA [2], and the sixth data line DL6 may be connected to the third data output line OL3 according to the second control signal CLB and may receive the third data signal DATA [3].

The first data line DL1 and the second data line DL2 which are neighboring each other and receive the data signals according to the same control signal may be arranged to face each other. The third data line DL3 and the fourth data line DL4, which are neighboring each other and receive data signals according to different control signals, may be arranged apart from each other with the third sub-pixel circuit columns PCb11, PCb21, and PCb31 and the fourth sub-pixel circuit columns PCr12, PCr22, and PCr32 therebetween, the third sub-pixel circuit columns PCb11, PCb21, and PCb31 being connected to the third data line DL3, and the fourth sub-pixel circuit columns PCr12, PCr22, and PCr32 being connected to the fourth data line DL4. Each of the data lines DL1, DL2, . . . , DL6 may be arranged on a first side or second side of a sub-pixel circuit column connected thereto.

The first data line DL1 may be connected to the first sub-pixel circuit columns PCr11, PCr21, and PCr31 and arranged on the second sides of the first sub-pixel circuit columns PCr11, PCr21, and PCr31, and the second data line DL2 may be connected to the second sub-pixel circuit columns PCg11, PCg21, and PCg31 and arranged on the first sides of the second sub-pixel circuit columns PCg11, PCg21, and PCg31.

The third data line DL3 may be connected to the third sub-pixel circuit columns PCb11, PCb21, and PCb31 and arranged on the first side of the third sub-pixel circuit columns PCb11, PCb21, and PCb31, and the fourth data line DL4 may be connected to fourth sub-pixel circuit columns PCr12, PCr22, and PCr32 and arranged on the second side of the fourth sub-pixel circuit columns PCr12, PCr22, and PCr32.

The fifth data line DL5 may be connected to fifth sub-pixel circuit columns PCg12, PCg22, and PCg32 and arranged on the first side of the fifth sub-pixel circuit columns PCg12, PCg22, and PCg32, and the sixth data line DL6 may be connected to sixth sub-pixel circuit columns PCb12, PCb22, and PCb32 and arranged on the first side of the sixth sub-pixel circuit columns PCb12, PCb22, and PCb32.

Sub-pixel circuits belonging to the first sub-pixel circuit columns PCr11, PCr21, and PCr31 may have a symmetrical shape with sub-pixel circuits belonging to the second sub-pixel circuit columns PCg11, PCg21, and PCg31. Sub-pixel circuits belonging to the fourth sub-pixel circuit columns PCr12, PCr22, and PCr32 may have a symmetrical shape with sub-pixel circuits belonging to the fifth sub-pixel circuit columns PCg12, PCg22, and PCg32.

The third sub-pixel circuit columns PCb11, PCb21, and PCb31 and the fourth sub-pixel circuit columns PCr12, PCr22, and PCr32 may overlap a driving voltage line (e.g., single driving voltage line). The sixth sub-pixel circuit columns PCb12, PCb22, and PCb32 and a seventh sub-pixel circuit column may overlap a driving voltage line (e.g., single driving voltage line). According to embodiments, the sub-pixel circuits in the third sub-pixel circuit columns PCb11, PCb21, and PCb31 and the fourth sub-pixel circuit columns PCr12, PCr22, and PCr32 may be flipped so that the third sub-pixel circuit columns PCb11, PCb21, and PCb31 and the fourth sub-pixel circuit columns PCr12, PCr22, and PCr32 may share a driving voltage line (e.g., single driving voltage line). Accordingly, an area required by the pixel circuit PCij may be reduced.

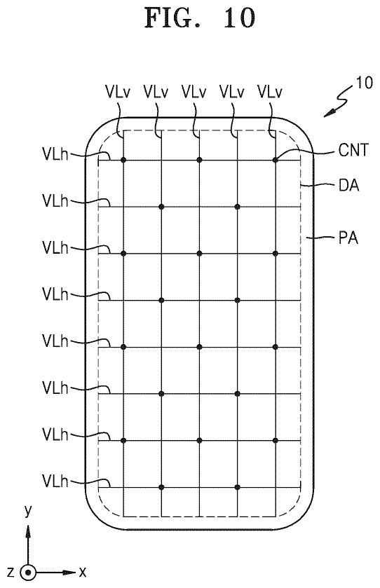

FIG. 10 is a schematic diagram for describing first voltage transfer lines VLv and second voltage transfer lines VLh according to an embodiment.

Referring to FIG. 10, the display apparatus 10 may include the display area DA and the peripheral area PA that is outside the display area DA. The first voltage transfer lines VLv extending in the second direction (y-axis direction) and the second voltage transfer lines VLh extending in the first direction (x-axis direction) may be arranged in the display area DA.

The first voltage transfer lines VLv and the second voltage transfer lines VLh may intersect each other and may have a mesh structure in a plan view. The first voltage transfer lines VLv and the second voltage transfer lines VLh may be disposed on different layers, and at least one insulating layer may be disposed between the first voltage transfer lines VLv and between the second voltage transfer lines VLh. The first voltage transfer lines VLv and the second voltage transfer lines VLh may be electrically connected to each other through contact holes CNT, which pass through the at least one insulating layer. The contact holes CNT may be arranged in the display area DA, and the first voltage transfer lines VLv and the second voltage transfer lines VLh may be electrically connected to each other in the display area DA.

The first voltage transfer lines VLv and the second voltage transfer lines VLh may be lines configured to transfer constant voltages. The constant voltage may include the driving voltage ELVDD (see FIGS. 2A to 2C), the common voltage ELVSS (see FIGS. 2A to 2C), the first initialization voltage VINT (see FIGS. 2A to 2C), the second initialization voltage VAINT (see FIGS. 2A to 2C), the bias voltage VOBS (see FIGS. 2A to 2C). In an embodiment, the second voltage transfer lines VLh may include the first initialization voltage line VL1 (see FIGS. 2A to 2C), the second initialization voltage line VL2 (see FIGS. 2A to 2C), or the bias voltage line VL3 (see FIGS. 2A to 2C).

By the first voltage transfer lines VLv and the second voltage transfer lines VLh, voltages of constant magnitudes may be transferred to the sub-pixel circuits regardless of the positions thereof. Accordingly, in the display apparatus 10 according to an embodiment, luminance deviation between pixels due to voltage drop may be prevented or reduced so that high-quality images may be displayed.

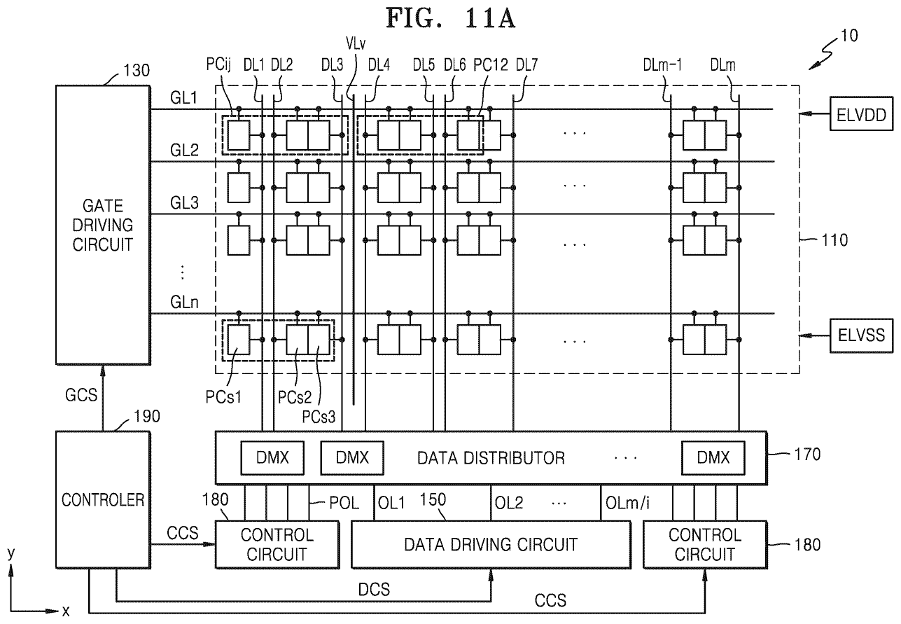

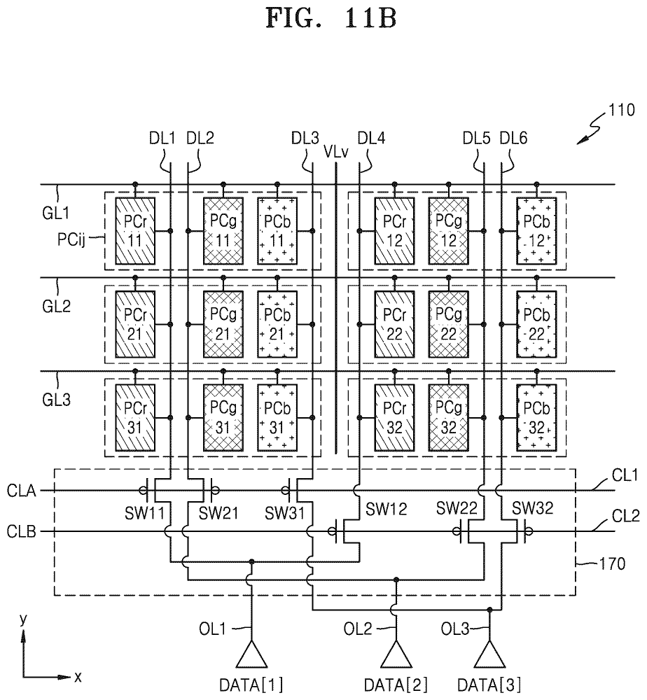

FIG. 11A is a schematic diagram schematically illustrating the display apparatus 10 according to an embodiment, and FIG. 11B is a schematic diagram for describing the display 110 and the data distributor 170 of the display apparatus 10 shown in FIG. 11A.

Referring to FIG. 11A, the display apparatus 10 may include the display 110, the gate driving circuit 130, the data driving circuit 150, the data distributor 170, the control circuits 180, and the controller 190.

The display 110 may include the pixel circuits PC, the gate lines GL1 to GLn, the data lines DL1 to DLm, and the first voltage transfer lines VLv. Each of the pixel circuits PCij may include the sub-pixel circuits PCs. For example, a pixel circuit PCij may include the first sub-pixel circuit PCs1, the second sub-pixel circuit PCs2, and the third sub-pixel circuit PCs3.

Each of the sub-pixel circuits PCs may be connected to a corresponding gate line of the gate lines GL1 to GLn and a corresponding data line of the data lines DL1 to DLm.

The gate driving circuit 130 may be connected to the gate lines GL1 to GLn and may generate gate signals in response to the gate driving control signal GCS from the controller 190 and sequentially supply the generated gate signals to the gate lines GL1 to GLn.

The data driving circuit 150 may be connected to the data output lines OL1 to OLm/i, and the data output lines OL1 to OLm/i may be connected to the data lines DL1 to DLm through the data distributor 170.

The first voltage transfer line VLv may be configured to transfer constant voltages. Here, the constant voltage may include the driving voltage ELVDD, the common voltage ELVSS, the first initialization voltage VINT (see FIGS. 2A to 2C), the second initialization voltage VAINT (see FIGS. 2A to 2C), the bias voltage VOBS (see FIGS. 2A to 2C).

The first voltage transfer line VLv may not be arranged for each pixel circuit PCij and may be arranged according to certain rules. For example, six data lines may be disposed between two neighboring first voltage transfer lines VLv. Here, the two neighboring first voltage transfer lines may indicate that no other first voltage transfer line may be disposed between the two first voltage transfer lines.

The control circuits 180 may be connected to the power output lines POL, and the power output lines POL may be connected to the data distributor 170. The control circuits 180 may supply control signals of sub-demultiplexer DMX to the data distributor 170 through the power output lines POL according to the distribution control signal CCS received from the controller 190.

An end of the sub-demultiplexer DMX may be connected to a corresponding data output line from among the data output lines OL1 to OLm/i. Another end of the sub-demultiplexer DMX may be connected to i data lines. The sub-demultiplexer DMX may supply a data signal received from the corresponding data output line to the i data lines.

The controller 190 may generate the data driving control signal DCS, the gate driving control signal GCS, and the distribution control signal CCS in response to synchronization signals received from the outside. The control circuits 180 may output the control signals of the sub-demultiplexers DMX in response to the distribution control signal CCS. The data distributor 170 may selectively connect the data output lines OL1 to OLm/i and the data lines DL1 to DLm to each other in response to the control signals of the sub-demultiplexers DMX.

The driving voltage ELVDD and the common voltage ELVSS may be supplied to the sub-pixel circuits PCs and the organic light-emitting diode OLED (see FIGS. 2A to 2C) of the display apparatus 10.

Referring to FIG. 11B, the data distributor 170 may include the first switches SW1 and the second switches SW2, and the display 110 may include the pixel circuits PC. A single pixel circuit PCij may include a red sub-pixel circuit PCr, a green sub-pixel circuit PCg, and a blue sub-pixel circuit PCb. The sub-pixel circuits PCr, PCg, and PCb may be repeatedly arranged in the first direction (x-axis direction, row direction) and the second direction (y-axis direction, column direction).

The data lines DL1, DL2, . . . , DL6, the gate lines GL1, GL2, and GL3, and the first voltage transfer lines VLv may be arranged in the display 110. Although not shown in FIG. 11B, the display 110 may further include the second voltage transfer lines VLh (see FIG. 10), which are electrically connected to the first voltage transfer lines VLv and extend in the first direction (x-axis direction).

One gate line may be connected to sub-pixel circuits arranged in the same row. A data line (e.g., single data line) may be connected to sub-pixel circuits arranged in the same column.

The data distributor 170 may selectively connect the data output lines OL1, OL2, and OL3 to one of a pair of corresponding data lines. For example, the data distributor 170 may selectively connect the first data output line OL1 to one of the first data line DL1 and the fourth data line DL4, selectively connect the second data output line OL2 to one of the second data line DL2 and the fifth data line DL5, and selectively connect the third data output line OL3 to one of the third data line DL3 and the sixth data line DL6.

The first switches SW1 may be respectively provided between the first data output line OL1 and the first data line DL1, between the second data output line OL2 and the second data line DL2, and between the third data output line OL3 and the third data line DL3. The first switches SW1 may be turned on according to the first control signal CLA and may connect the first data output line OL1 and the first data line DL1 to each other, connect the second data output line OL2 and the second data line DL2 to each other, and connect the third data output line OL3 and the third data line DL3 to each other.

The second switches SW2 may be respectively provided between the first data output line OL1 and the fourth data line DL4, between the second data output line OL2 and the fifth data line DL5, and between the third data output line OL3 and the sixth data line DL6. The second switches SW2 may be turned on according to the second control signal CLB and may connect the first data output line OL1 and the fourth data line DL4 to each other, connect the second data output line OL2 and the fifth data line DL5 to each other, and connect the third data output line OL3 and the sixth data line DL6 to each other.

The control circuit 180 (see FIG. 3) may supply the first control signal CLA to the first switches SW1 through the first control signal line CL1 and supply the second control signal CLB to the second switches SW2 through the second control signal line CL2.

The data lines DL1, DL2, . . . , DL6 may be divided into a first group and a second group. The first group includes the first data line DL1, the second data line DL2, and the third data line DL3, which receive data signals according to the first control signal CLA and may be sequentially arranged in the first direction (x-axis direction). The second group includes the fourth data line DL4, the fifth data line DL5, and the sixth data line DL6, which receive data signals according to the second control signal CLB and may be sequentially arranged in the first direction (x-axis direction). The first group and the second group may be alternately arranged in the first direction (x-axis direction).

Odd-numbered sub-pixel circuit columns may have a flipped shape. Accordingly, one of the odd-numbered data lines DL1, DL3, and DL5 and one of the even-numbered data lines DL2, DL4, and DL6 neighboring each other may be arranged to face each other in pairs, respectively. For example, the first data line DL1 and the second data line DL2 may be arranged to face each other, the third data line DL3 and the fourth data line DL4 may be arranged to face each other, and the fifth data line DL5 and the sixth data line DL6 may be arranged to face each other.

The first voltage transfer line VLv may be disposed between the third data line DL3 and the fourth data line DLA. The third data line DL3 and the fourth data line DL4, which receive data signals according to different control signals, respectively, may be arranged apart from each other with the first voltage transfer line VLv therebetween, thereby reducing or preventing coupling between the two data lines.

Each of the data lines DL1, DL2, . . . , DL6 may be arranged on a first side (left side) or second side (right side) of a sub-pixel circuit column connected thereto. Each of the odd-numbered data lines DL1, DL3, and DL5 may be arranged on the second side of a sub-pixel circuit column connected thereto, and each of the even-numbered data lines DL2, DL4, and DL6 may be arranged on the first side of a sub-pixel circuit column connected thereto.

In other words, the first data line DL1 may be connected to the first sub-pixel circuit columns PCr11, PCr21, and PCr31 and arranged on the second sides of the first sub-pixel circuit columns PCr11, PCr21, and PCr31, and the second data line DL2 may be connected to the second sub-pixel circuit columns PCg11, PCg21, and PCg31 and arranged on the first sides of the second sub-pixel circuit columns PCg11, PCg21, and PCg31.

The third data line DL3 may be connected to the third sub-pixel circuit columns PCb11, PCb21, and PCb31 and arranged on first sides of the third sub-pixel circuit columns PCb11, PCb21, and PCb31, and the fourth data line DL4 may be connected to fourth sub-pixel circuit columns PCr12, PCr22, and PCr32 and arranged on first sides of the fourth sub-pixel circuit columns PCr12, PCr22, and PCr32.

The fifth data line DL5 may be connected to the fifth sub-pixel circuit columns PCg12, PCg22, and PCg32 and arranged on the second sides of the fifth sub-pixel circuit columns PCg12, PCg22, and PCg32, and the sixth data line DL6 may be connected to sixth sub-pixel circuit columns PCb12, PCb22, and PCb32 and arranged on the first sides of the sixth sub-pixel circuit columns PCb12, PCb22, and PCb32.

In an embodiment, sub-pixel circuits belonging to the first sub-pixel circuit columns PCr11, PCr21, and PCr31 may have a symmetrical shape with sub-pixel circuits belonging to the second sub-pixel circuit columns PCg11, PCg21, and PCg31.

The second sub-pixel circuit columns PCg11, PCg21, and PCg31 and the third sub-pixel circuit columns PCb11, PCb21, and PCb31 may overlap a driving voltage line (e.g., single driving voltage line).

Sub-pixel circuits belonging to the fourth sub-pixel circuit columns PCr12, PCr22, and PCr32 may have a symmetrical shape with sub-pixel circuits belonging to the fifth sub-pixel circuit columns PCg12, PCg22, and PCg32. The fourth sub-pixel circuit columns PCr12, PCr22, and PCr32 and the fifth sub-pixel circuit columns PCg12, PCg22, and PCg32 may overlap a driving voltage line (e.g., single driving voltage line).

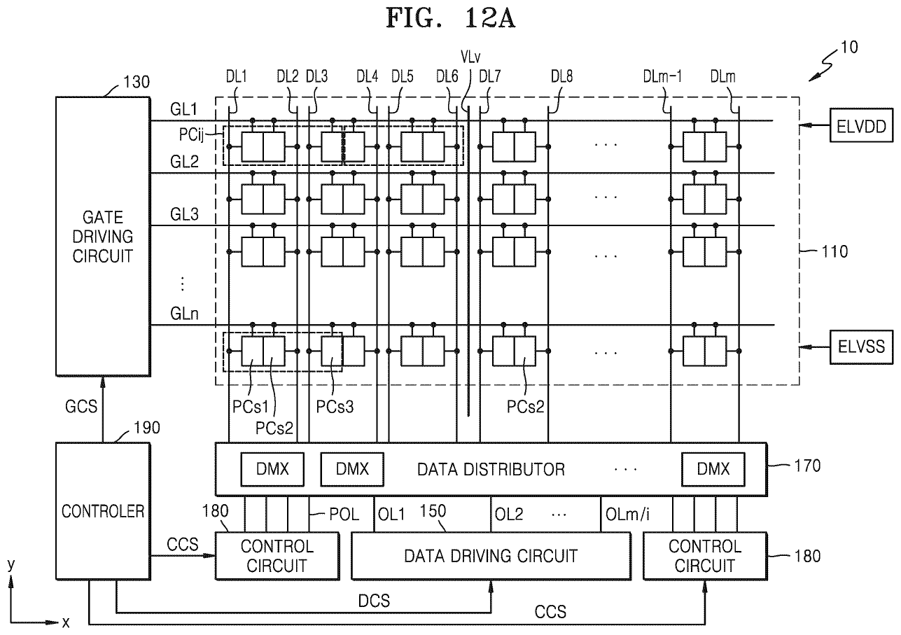

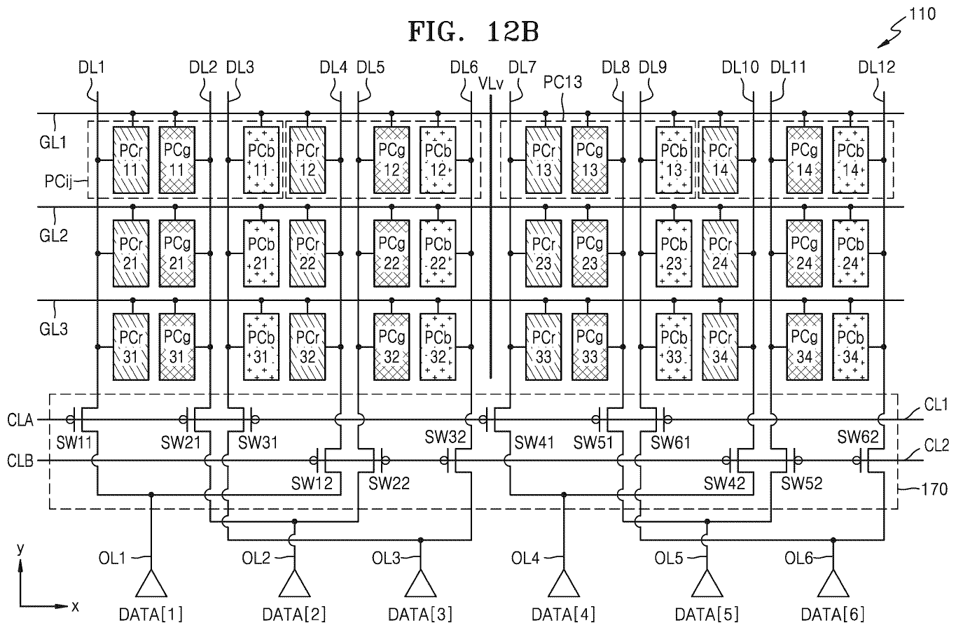

FIG. 12A is a diagram schematically illustrating the display apparatus 10 according to an embodiment, and FIG. 12B is a schematic diagram for describing the display 110 and the data distributor 170 of the display apparatus 10 shown in FIG. 12A.

FIGS. 12A and 12B are similar to FIGS. 11A and 11B, respectively, but differ from FIGS. 11A and 11B with respect to the arrangement of sub-pixel circuits, data lines, and first voltage transfer lines. Hereinbelow, descriptions of the same or similar elements are omitted, and differences are mainly described.

Referring to FIGS. 12A and 12B, the first to sixth data lines DL1, DL2, . . . , DL6 may be divided into a first group and a second group. The first group includes the first data line DL1, the second data line DL2, and the third data line DL3, which receive data signals according to the first control signal CLA and may be sequentially arranged in the first direction (x-axis direction). The second group includes the fourth data line DL4, the fifth data line DL5, and the sixth data line DL6, which receive data signals according to the second control signal CLB and may be sequentially arranged in the first direction (x-axis direction).

Seventh to twelfth data lines DL7, DL8, . . . , DL12 may be divided into a first group and a second group. The first group includes the seventh data line DL7, the eighth data line DL8, and the ninth data line DL9, which receive data signals according to the first control signal CLA and may be sequentially arranged in the first direction (x-axis direction). The second group includes the tenth data line DL10, the eleventh data line DL11, and the twelfth data line DL12, which receive data signals according to the second control signal CLB and may be sequentially arranged in the first direction (x-axis direction). In other words, the first group and the second group may be alternately arranged in the first direction (x-axis direction).

Even-numbered sub-pixel circuit columns may have a flipped shape. Accordingly, one of the even-numbered data lines DL2, DL4, DL6, DL8, and DL10 and one of the odd-numbered data lines DL3, DL5, DL7, DL9, and DL11 neighboring each other may be arranged to face each other in pairs, respectively. For example, the second data line DL2 and the third data line DL3 may be arranged to face each other, the fourth data line DLA and the fifth data line DL5 may be arranged to face each other, the sixth data line DL6 and the seventh data line DL7 may be arranged to face each other, the eighth data line DL8 and the ninth data line DL9 may be arranged to each other, and the tenth data line DL10 and the eleventh data line DL11 may be arranged to face each other.

Two sub-pixel circuit columns may be disposed between the third data line DL3 and the fourth data line DL4, the first voltage transfer line VLv may be disposed between the sixth data line DL6 and the seventh data line DL7, and two sub-pixel circuit columns may be disposed between the ninth data line DL9 and the tenth data line DL10. Two data lines neighboring each other and receiving data signals according to different control signals, respectively, may be arranged apart from each other with two sub-pixel circuit columns or the first voltage transfer line VLv therebetween, thereby reducing or preventing coupling.

Each of the data lines DL1, DL2, . . . , DL6 may be arranged on the first side (left side) or second side (right side) of a sub-pixel circuit column connected thereto. Each of the odd-numbered data lines DL1, DL3, and DL5 may be arranged on the first side of a sub-pixel circuit column connected thereto, and each of the even-numbered data lines DL2, DL4, and DL6 may be arranged on the second side of a sub-pixel circuit column connected thereto.

In an embodiment, a pair of sub-pixel circuit columns disposed between two data lines may overlap a driving voltage line (e.g., single driving voltage line). For example, the first sub-pixel circuit columns PCr11, PCr21, and PCr31 and the second sub-pixel circuit columns PCg11, PCg21, and PCg31 may overlap a driving voltage line (e.g., single driving voltage line).

According to the one or more embodiments, a display apparatus on which high-quality images may be displayed may be implemented while reducing the number of output lines in a data output portion. However, the scope of one or more embodiments is not limited by these effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A display apparatus comprising:
a display comprising sub-pixel circuits arranged in a row direction and a column direction and data lines connected to corresponding sub-pixel circuits;
a data driving circuit that outputs data signals through output lines;
a data distributor selectively connecting each of the output lines to one of a corresponding pair of data lines among the data lines according to a first control signal and a second control signal; and
a control circuit that alternately outputs the first control signal and the second control signal, wherein
the data lines comprise a first data line, a second data line, a third data line, and a fourth data line,
the first data line and the second data line are neighboring each other and receive corresponding data signal, respectively, according to different ones of the first control signal and the second control signal,
the third data line and the fourth data line are neighboring each other and receive corresponding data signal, respectively according to a same one of the first control signal and the second control signal,
the first data line and the second data line are spaced apart from each other by at least one sub-pixel circuit column, and
two neighboring data lines among the first data line, the second data line, the third data line, and the fourth data line are arranged to face each other.

2. The display apparatus of claim 1, wherein
each of the data lines is arranged on either a first side or a second side of a corresponding sub-pixel circuit column,
the third data line is arranged on the second side of the corresponding sub-pixel circuit column, and
the fourth data line is arranged on the first side of the corresponding sub-pixel circuit

3. The display apparatus of claim 2, wherein
the data lines further comprise a fifth data line and a sixth data line,
the fifth data line and the sixth data line are neighboring each other and receive corresponding data signal, respectively according to a same one of the first control signal and the second control signal,
the fifth data line is connected to a first output line from among the output lines according to the first control signal,
the sixth data line is connected to a second output line from among the output lines according to the first control signal,
the first data line is connected to a third output line from among the output lines according to the first control signal, and
the second data line is connected to the first output line according to the second control signal,
the third data line is connected to the second output line according to the second control signal, and
the fourth data line is connected to the third output line according to the second control signal.

4. The display apparatus of claim 3, wherein each of the first data line and the second data line is arranged on the first side of the corresponding sub-pixel circuit column.

5. The display apparatus of claim 4, wherein a sub-pixel circuit column that is connected to the first data line is disposed between the first data line and the second data line.

6. The display apparatus of claim 4, wherein
the fifth data line is disposed on the first side of the corresponding sub-pixel circuit column, and
the sixth data line is disposed on the second side of the corresponding sub-pixel circuit

7. The display apparatus of claim 4, wherein a sub-pixel circuit column connected to the fifth data line and a sub-pixel circuit column connected to the sixth data line overlap a single driving voltage line.

8. The display apparatus of claim 3, wherein
the first data line is arranged on the first side of the corresponding sub-pixel circuit column, and
the second data line is arranged on the second side of the corresponding sub-pixel circuit column.

9. The display apparatus of claim 8, wherein the sub-pixel circuit column that is connected to the first data line and the sub-pixel circuit column that is connected to the second data line overlap a single driving voltage line.

10. The display apparatus of claim 8, wherein the fifth data line and the sixth data line are to face each other.

11. A display apparatus comprising:
a display comprising sub-pixel circuits arranged in a row direction and a column direction, data lines connected to corresponding sub-pixel circuits, and first voltage transfer lines extending in the column direction;
a data driving circuit that outputs a data signal through output lines;
a data distributor selectively connecting each of the output lines to one of a corresponding pair of data lines among the data lines according to a first control signal and a second control signal; and
a control circuit that alternately outputs the first control signal and the second control signal, wherein
the data lines comprise first groups and second groups,
each of the first groups comprise a first data line, a second data line, and a third data line that are sequentially arranged in the row direction and that receive data signals according to the first control signal,
each of the second groups comprise a fourth data line, a fifth data line, and a sixth data line that are sequentially arranged in the row direction and that receive data signals according to the second control signal,
the first groups and the second groups are alternately arranged in the row direction, and
one of the first voltage transfer lines is disposed between the third data line and the fourth data line.

12. The display apparatus of claim 11, wherein
each of the data lines is arranged on either a first side or a second side of a corresponding sub-pixel circuit column,
each of odd-numbered data lines is arranged on the second side of the corresponding sub-pixel circuit column, and
each of even-numbered data lines is arranged on the first side of the corresponding sub-pixel circuit column.

13. The display apparatus of claim 11, wherein
the first data line is connected to a first output line from among the output lines according to the first control signal,
the second data line is connected to a second output line from among the output lines according to the first control signal,
the third data line is connected to a third output line from among the output lines according to the first control signal,
the fourth data line is connected to the first output line according to the second control signal,
the fifth data line is connected to the second output line according to the second control signal, and
the sixth data line is connected to the third output line according to the second control signal.

14. The display apparatus of claim 11, wherein
the display further comprises second voltage transfer lines extending in the row direction, and
the first voltage transfer lines are connected to the second voltage transfer lines.

15. The display apparatus of claim 11, wherein six data lines are disposed between two neighboring first voltage transfer lines from among the first voltage transfer lines.

16. A display apparatus comprising:
a display comprising sub-pixel circuits arranged in a row direction and a column direction, data lines connected to corresponding sub-pixel circuits, and first voltage transfer lines extending in the column direction;
a data driving circuit that outputs a data signal through output lines;
a data distributor selectively connecting each of the output lines to one of a corresponding pair of data lines among the data lines according to a first control signal and a second control signal; and
a control circuit that alternately outputs the first control signal and the second control signal, wherein
the data lines comprise first groups and second groups,
each of the first groups comprise a first data line, a second data line, and a third data line that are sequentially arranged in the row direction and that are connected to a corresponding one of the output lines according to the first control signal,
each of the second groups comprise a fourth data line, a fifth data line, and a sixth data line that are sequentially arranged in the row direction and that are connected to a corresponding one of the output lines according to the second control signal,
the first group and the second group are alternately arranged in the row direction, and
one of the first voltage transfer lines is disposed between the sixth data line and the first data line.

17. The display apparatus of claim 16, wherein
each of the data lines is arranged on either a first side or a second side of a corresponding sub-pixel circuit column,
each of odd-numbered data lines is arranged on the first side of the corresponding sub-pixel circuit column, and
each of even-numbered data lines is arranged on the second side of the corresponding sub-pixel circuit column.

18. The display apparatus of claim 16, wherein
the first data line is connected to a first output line from among the output lines according to the first control signal,
the second data line is connected to a second output line from among the output lines according to the first control signal,
the third data line is connected to a third output line from among the output lines according to the first control signal,
the fourth data line is connected to the first output line according to the second control signal,
the fifth data line is connected to the second output line according to the second control signal, and
the sixth data line is connected to the third output line according to the second control signal.

19. The display apparatus of claim 16, wherein
the display further comprises second voltage transfer lines extending in the row direction, and
the first voltage transfer lines are connected to the second voltage transfer lines.

20. The display apparatus of claim 16, wherein six data lines are disposed between two neighboring first voltage transfer lines from among the first voltage transfer lines.

21. An electronic device comprising the display apparatus of claim 1.

22. The electronic device of claim 21, wherein, the electronic device is a mobile phone, a smartphone, a tablet personal computer, a mobile communication terminal, an electronic notebook, an electronic book, a portable multimedia player, a navigation, an ultra-mobile PC, a television, a laptop, a monitor, a billboard, an Internet-of-Things device, a smart watch, a watch phone, a glasses-type display, a head-mounted display, a center information display disposed on a center fascia or dashboard of a vehicle, a room mirror display, or a display disposed on a rear surface of a front seat of the vehicle.

23. An electronic device comprising the display apparatus of claim 11.

24. The electronic device of claim 23, wherein, the electronic device is a mobile phone, a smartphone, a tablet personal computer, a mobile communication terminal, an electronic notebook, an electronic book, a portable multimedia player, a navigation, an ultra-mobile PC, a television, a laptop, a monitor, a billboard, an Internet-of-Things device, a smart watch, a watch phone, a glasses-type display, a head-mounted display, a center information display disposed on a center fascia or dashboard of a vehicle, a room mirror display, or a display disposed on a rear surface of a front seat of the vehicle.

25. An electronic device comprising the display apparatus of claim 16.

26. The electronic device of claim 25, wherein, the electronic device is a mobile phone, a smartphone, a tablet personal computer, a mobile communication terminal, an electronic notebook, an electronic book, a portable multimedia player, a navigation, an ultra-mobile PC, a television, a laptop, a monitor, a billboard, an Internet-of-Things device, a smart watch, a watch phone, a glasses-type display, a head-mounted display, a center information display disposed on a center fascia or dashboard of a vehicle, a room mirror display, or a display disposed on a rear surface of a front seat of the vehicle.
